(19) United States
(12) Patent Application Publication
(10) Pub. No.: US 2005/0218249 A1
(43) Pub. Date: Oct. 6, 2005

(54) Electro-magnetic driver and fuel injection valve using the same

(75) Inventor: Koichi Sugiyama, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/091,897

(22) Filed: Mar. 29, 2005

(30) Foreign Application Priority Data
Mar. 30, 2004 (JP) 2004-97729
Apr. 28, 2004 (JP) 2004-133063
Oct. 15, 2004 (JP) 2004-301688

(51) Int. Cl. B05B 1/30; F02M 51/00

(52) U.S. Cl. 239/585.1

(57) ABSTRACT

A housing can be of simple structure because the first wall portion, the second wall portion, and a side portion are integrally formed. The housing is brought into contact with the resin-formed part of a coil at an end opposite to the side portion of the second wall portion. This prevents the relative turn in the peripheral direction between the coil and the housing and the movement to the side portion of the coil. On this account, the positional relationship between the coil and the housing can be prevented from becoming incorrect and the winding or the wiring part of the coil through which current flows can be prevented from being brought into contact with the housing of a conducting body. The positional relationship between the coil and the housing can be determined with precision without causing the complex structure of the coil and the housing.

### CROSS-REFERENCE TO RELATED APPLICATION

This application is based on Japanese Patent Applications No. 2004-97729 filed on Mar. 30, 2004, No. 2004-133063 filed on Apr. 28, 2004, and No. 2004-301688 filed on Oct. 15, 2004, the disclosures of which are incorporated herein by reference.

### FIELD OF THE INVENTION

The present invention relates to an electro-magnetic driver and a fuel injection valve using the same.

### BACKGROUND OF THE INVENTION

A device provided with an electro-magnetic driver, like a fuel injection valve injecting the fuel of an internal combustion engine (hereinafter referred to as “engine”), has been publicly known. As described in JP-5-79424A, the electromagnetic driver is provided with a coil for generating a magnetic field and a magnetic member for forming a magnetic circuit through which a magnetic flux is made to flow by the magnetic field generated by the coil. In the electro-magnetic driver like this, when the coil is received in the magnetic member, the coil is sandwiched by the magnetic member divided into a plurality of parts.

The divided half parts are so mounted on the coil as to cover the coil from outside in the radial direction after the coil is mounted in, for example, a cylindrical part. For this reason, there is required a process of mounting the divided magnetic parts and connecting the mounted magnetic parts. As a result, this increases the number of parts and makes a structure complex and increases the number of man-hours required to mount the parts.

In the case of a fuel injection valve disclosed in JP-5-79424A, the housing of a magnetic part is fixed to a yoke by caulking an end portion on an injection port side. Further, in the case of a fuel injection valve disclosed in JP-2002-21678A, the housing is fixed to a yoke by welding an end portion on the injection port side of the housing of a magnetic part. In the case of fixing the housing by caulking or welding the magnetic member, like the fuel injection valves disclosed in these patent documents, it is difficult to control the precise position of the magnetic member with respect to the cylindrical member. Further, there is presented a problem of requiring a separate process for caulking or welding and increasing the number of working man-hours.

### SUMMARY OF THE INVENTION

Therefore, the object of the invention is to provide an electromagnetic driver easily mounted without increasing the number of parts and without making a structure complex and a fuel injection nozzle using the same.

According to the invention, a magnetic part covering the outside of a coil is integrally formed as a whole without a seam. On this account, the magnetic part is of simple structure and hence the number of parts is reduced. The magnetic part has an opening in which an internal part is received. Further, since the magnetic part is integrally formed, the internal part is mounted in the magnetic part by inserting the internal part into the opening of the magnetic part. Hence, the mounting of the internal part in the magnetic part can be easily performed and hence the number of mounting man-hours can be reduced. In the present specification, the internal part means a part, for example, inserted or pressed into the inner peripheral side of the magnetic part. The internal part includes, for example, a part that is made of a magnetic material and forms a magnetic circuit such as fixed core and moving core, a part that is made of a non-magnetic material and prevents a magnetic short circuit between parts made of a magnetic material, and a part that receives a part made of a magnetic material and a part made of a non-magnetic material.

The relative position in the axial direction of the magnetic part with respect to an internal part is determined by a holding part. That is, the holding part is mounted on the outer peripheral side of the internal part, thereby being brought into contact with the magnetic part. The relative position in the axial direction of the magnetic part with respect to the internal part is determined by the holding part mounted in the internal part mounted in the inner peripheral side of the magnetic part. By adjusting the position of the holding part mounted in the internal part, the relative position of the magnetic part with respect to the internal part can be easily set. Therefore, the position of the magnetic part with respect to the internal part can be determined by a simple structure.

### BRIEF DESCRIPTION OF THE DRAWINGS

FIG. 1 is a sectional view illustrating an injector in accordance with the first embodiment of the invention.

FIG. 2 is a schematic perspective view illustrating the coil of the injector in accordance with the first embodiment of the invention.

FIG. 3 is a sectional view illustrating the coil of the injector in accordance with the first embodiment of the invention.

FIG. 4 is a schematic perspective view illustrating the housing of the injector in accordance with the first embodiment of the invention.

FIG. 5 is a view illustrating the coil and housing of the injector in accordance with the first embodiment of the invention and is a schematic view when viewed from the second wall side of the housing.

FIG. 6 is a sectional view illustrating a procedure of mounting the injector in accordance with the first embodiment of the invention.

FIG. 7 is a schematic perspective view illustrating the housing of an injector in accordance with the second embodiment of the invention.

FIGS. 8A to 8C are views illustrating the coil of the injector in accordance with the second embodiment of the invention. FIG. 8A is a schematic view when viewed from the second wall portion side of the housing and FIG. 8B is a sectional view along a line VIII B-VIIIB in FIG. 8A, and FIG. 8C is s a sectional view along a line VIIIC-VIIIC in FIG. 8A.

FIG. 9 is a view illustrating the coil and housing of the injector in accordance with the second embodiment of the invention and is a perspective view when viewed from the second wall portion side of the housing.

FIG. 10 is a sectional view illustrating an injector coil in accordance with the third embodiment of the invention.

FIG. 11 is a schematic perspective view illustrating the coil of the injector in accordance with the third embodiment of the invention.

FIG. 12 is a schematic perspective view illustrating the housing of the injector in accordance with the third embodiment of the invention.

FIG. 13 is a view when viewed from a direction shown by an arrow XIII in FIG. 11.

FIG. 14 is a schematic perspective view illustrating the housing of an injector in accordance with the fourth embodiment of the invention.

FIGS. 15A and 15B are sectional views illustrating the coil of the injector in accordance with the fourth embodiment of the invention.

FIG. 16 is a schematic view of the coil of an injector in accordance with the fifth embodiment of the invention when viewed from the second wall portion side of the housing.

FIG. 17 is a view illustrating the coil and housing of the injector in accordance with the fifth embodiment of the invention and is a schematic view when viewed from the second wall portion side of the housing.

FIG. 18 is a schematic view of the coil of an injection in accordance with the sixth embodiment of the invention when viewed from the second wall portion side of the housing.

FIG. 19 is a view illustrating the coil and housing of the injector in accordance with the sixth embodiment of the invention and is a schematic view when viewed from the second wall portion side of the housing.

FIG. 20 is a view illustrating the coil and housing of an injector in accordance with the seventh embodiment of the invention and is a schematic view when viewed from the second wall portion side of the housing.

FIG. 21 is a sectional view illustrating an injector in accordance with the eighth embodiment of the invention.

FIGS. 22A and 22B are views illustrating the housing of the injector in accordance with the eighth embodiment of the invention, and FIG. 22A is a schematic perspective view and FIG. 22B is a developed view.

FIG. 23 is a schematic perspective view of the coil and housing of the injector in accordance with the eighth embodiment of the invention.

FIG. 24 is a schematic view of the coil and housing of the injector in accordance with the eighth embodiment of the invention when viewed from the opposite side of an injection port.

FIG. 25 is a modification of the coil and housing of the injector in accordance with the eighth embodiment of the invention and is a schematic view when viewed from the opposite side of an injection port.

FIG. 26 is a sectional view illustrating an injector coil in accordance with the ninth embodiment of the invention.

FIG. 27 is a sectional view illustrating the housing of the injector in accordance with the ninth embodiment of the invention.

FIG. 28 is a sectional view illustrating the receiving pipe, coil, and housing of the injector in accordance with the ninth embodiment of the invention.

FIG. 29 is a sectional view illustrating the receiving pipe, coil, and housing of the injector in accordance with the ninth embodiment of the invention.

FIG. 30 is a schematic view of the housing of the injector in accordance with the ninth embodiment of the invention when viewed from the opposite side of an injection port and is a view illustrating a state where a protrusion is bent.

FIG. 31 is a sectional view illustrating an injector in accordance with the tenth embodiment of the invention.

FIG. 32 is a schematic view of the housing of the injector in accordance with the tenth embodiment of the invention when viewed from the opposite side of an injection port.

FIG. 33 is a sectional view illustrating the receiving pipe, coil, and housing of the injector in accordance with the tent h embodiment of the invention.

FIG. 34 is a partial sectional view illustrating the receiving pipe, coil, and housing of the injector in accordance with the tenth embodiment of the invention.

FIGS. 35A and 35B are views illustrating the housing of an injector in accordance with the eleventh embodiment of the invention, FIG. 35A is a schematic view when viewed from the opposite side of an injection port and FIG. 35B is a view when viewed from a lower side in FIG. 35A.

FIG. 36 is a sectional view illustrating an injector coil in accordance with the twelfth embodiment of the invention.

FIG. 37 is a partial sectional view illustrating the receiving pipe, coil, and housing of the injector in accordance with the twelfth embodiment of the invention.

FIG. 38 is a sectional view illustrating an injector in accordance with the thirteenth embodiment of the invention.

FIG. 39 is a partial sectional view illustrating the receiving pipe, coil, and housing of the injector in accordance with the thirteenth embodiment of the invention.

FIG. 40 is a plan view illustrating the ring of the injector in accordance with the first embodiment of the invention.

FIG. 41 is a schematic view illustrating the mounting of the injector in accordance with the first embodiment of the invention.

### DETAILED DESCRIPTION OF THE PREFERRED EMBODIMENTS

Hereafter, a plurality of preferred embodiments of the invention will be described on the basis of the drawings.

### First Embodiment

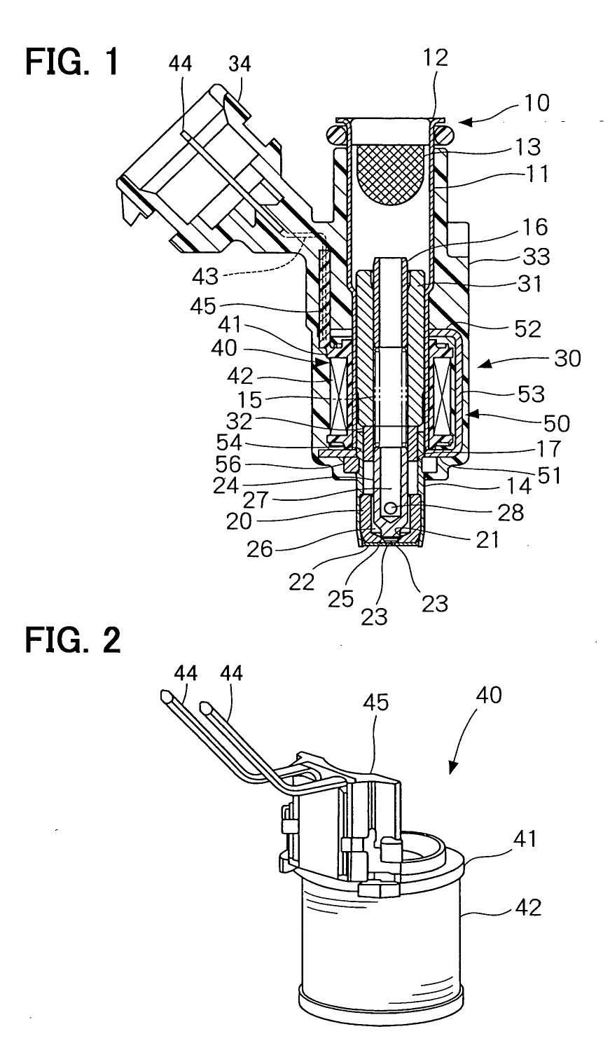

A fuel injection valve (hereinafter referred to as “injector”) to which an electromagnetic driver in accordance with the first embodiment of the invention is applied is shown in FIG. 1. An injector 10 in accordance with the first embodiment injects fuel to, for example, a gasoline engine. Here, the injector 10 may be applied to a direct injection type gasoline engine in which fuel is injected directly into the combustion chamber of a gasoline engine or may be applied to a diesel engine.

The receiving pipe 11 of the injector 10 is formed nearly in the shape of a cylinder having a thin thickness. The receiving pipe 11 is formed integrally from one end in an axial direction to the other end without a seam. The receiving pipe 11 may be formed of either a non-magnetic material or a magnetic material. One end in the axial direction of the receiving pipe 11 forms-a fuel inlet 12. Fuel is supplied to the fuel inlet 12 from a fuel pump (not shown). The fuel supplied to the fuel inlet 12 flows into the inner peripheral side of the receiving pipe 11 through a fuel filter 13. The fuel filter 13 is provided at the end of the receiving pipe 11 and removes foreign matters included in the fuel.

A nozzle holder 14 is provided at the end opposite to the fuel inlet 12 of the receiving pipe 11. The receiving pipe 11 and the nozzle holder 14 construct an internal part as claimed in claims. The nozzle holder 14 is formed of a magnetic material nearly in the shape of a cylinder and has a valve body 20 mounted therein. Here, the receiving pipe 11 and the nozzle holder 14 are not necessarily formed of separate parts but may be integrally formed.

The valve body 20 is formed nearly in the shape of a cylinder and is fixed to the end opposite to the receiving pipe 11 of the nozzle holder 14. The valve body 20 has a valve seat 21 on a conical inside wall of which diameter becomes smaller as a position comes nearer to a tip. The valve body 20 has an injection port plate 22 on the end opposite to the receiving pipe 11. The injection port plate 22 covers the end opposite to the receiving pipe 11 of the valve body 20 and is fixed to the valve body 20. The injection port plate 22 has an injection port 23 that connects an end surface on the valve body 20 side and an end surface opposite to the valve body 20.

A needle 24 as a valve part is received in the inner peripheral side of the nozzle holder 14 in such a way as to reciprocate in the axial direction. The needle 24 is arranged nearly coaxially with the nozzle holder 14. The needle 24 is formed nearly in the shape of a cylinder and has an abutting portion 25 near the end of the injection port plate 22 side. The abutting portion 25 can come into contact with the valve seat 21 formed on the valve body 20. The needle 24 forms a fuel passage 26 between itself and the valve body 20. The needle 24 forms a fuel passage 27, through which the fuel flows, in the inner peripheral side. The needle 24 has a fuel port 28 that connects the fuel passage in the inner peripheral side and the fuel passage in the outer peripheral side.

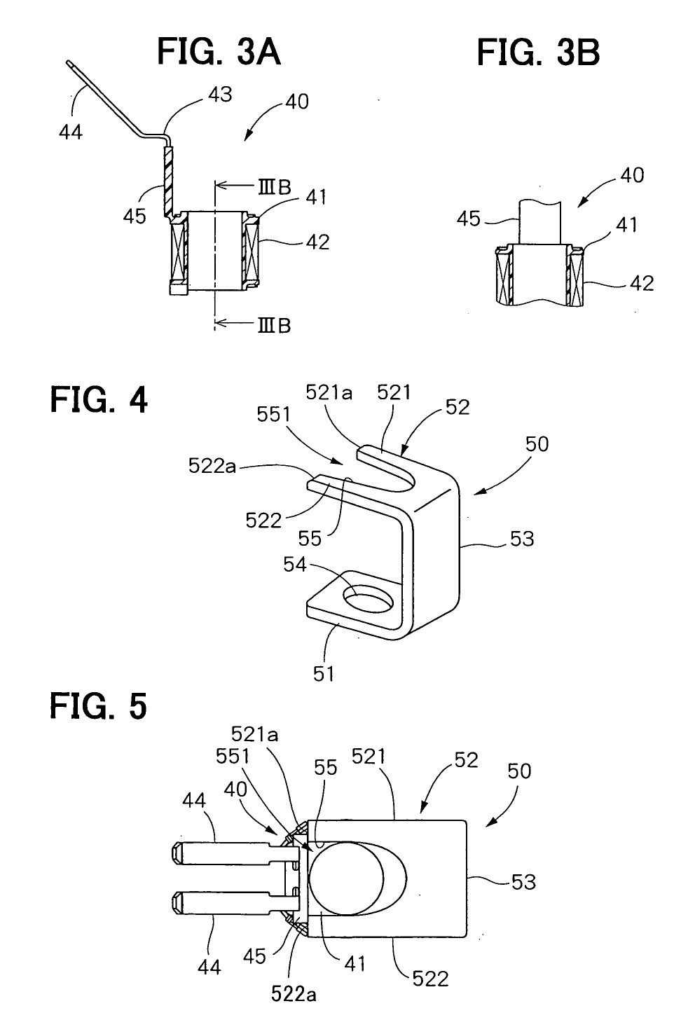

The injector 10 is provided with a driving unit 30 as an electromagnetic driver for driving the needle 24. The driving unit 30 has a coil 40, a fixed core 31, a housing 50 as a magnetic part, and a moving core 32. The driving unit 30 is constructed of the receiving pipe 11 of the internal part, and the nozzle holder 14 in addition to the coil 40, the fixed core 31, the housing 50 and the moving core 32. The coil 40, as shown in FIGS. 2 and 3, has a spool 41 and a winding 42. The spool 41 is formed of resin in the shape of a cylinder. The winding 42 is wound on the outer peripheral side of the spool 41. The coil 40 has a wiring part 43 connected to the winding 42 and a terminal 44 connected to the end opposite to the winding 42 of the wiring part 43. The spool 41 has a resin-formed part 45 protruding to one end in the axial direction. The resin-formed part 45 has the wiring part 43 connected to the winding 42 inserted therein and is formed of resin integrally with the spool 41. The receiving pipe 11 is inserted into the inner peripheral side of the spool 41 shaped like a cylinder. With this, the coil 40 is provided on the outer peripheral side of the receiving pipe 11.

The fixed core 31 is provided in the inner peripheral side of the coil 40 across the receiving pipe 11. The fixed core 31 is formed of a magnetic material such as iron in the shape of a cylinder. The outer peripheral side of the coil 40, the housing 50, and the receiving pipe 11 is covered with a resin mold 33. The winding 42 of the coil 40 is electrically connected to the terminal 44 via the wiring part 43. The terminal 44 is mounted in a connector 34. The connector 34 is integrally formed with the resin mold 33. The receiving pipe 11, the nozzle holder 14, and the fixed core 31 as the internal part described above construct an internal part as claimed in claims. Here, when the internal part is inserted into the inner peripheral side of the coil 40 such as moving core and needle, the internal part is not limited to the receiving pipe 11, the nozzle holder 14, and the fixed core 31 as described in this embodiment.

The housing 50 is formed of a magnetic material and covers both ends in the axial direction of the coil 40 and the outside in the radial direction of the coil 40. The housing 50, as shown in FIG. 4, has a first wall portion 51, a second wall portion 52, and a side portion 53. The side portion 53 extends along the axial direction outside in the radial direction of the coil 40. With this, the side portion 53 covers a portion in a peripheral direction outside in the radial direction of the coil 40. The first wall portion 51 and the second wall portion 52 are connected to both ends in the axial direction of the side portion 53, respectively. The first wall portion 51 covers the coil 40 o n the valve body 20 side of the side portion 53. The second wall portion 52 covers the coil 40 on the side opposite to the valve body 20 of the side portion 53. With this, the housing 50 is formed in the shape of a letter C in section along the axis.

The first wall portion 51 of the housing 50 has in the center a first opening 54 having the nozzle holder 14 inserted. The inner wall of the first wall portion 51 forming the first opening 54 is in contact with the outer wall of the nozzle holder 14. When the nozzle holder 14 is mounted in the first opening 54 of the first wall portion 51, the nozzle holder 14 is surrounded all around the periphery in the peripheral direction by the first wall portion 51 of the housing 50. That is, the first wall portion 5 1 forms the surrounding part as claimed in claims.

The second wall portion 52 of the housing 50 has a second opening 55. The second wall portion 52 has a cutout 551 extending from the second opening 55 to an outer peripheral edge. Hence, the second opening 55 is open to the outside of the second wall portion 52. With this, the second wall portion 52 has support portions 521 and 522 for supporting both ends in the radial direction of the receiving pipe 11 across the second opening 55 and the cutout 551. The support portions 521 and 522 forming the second opening 55 are in contact with the receiving pipe 11. Hence, the housing 50 is in contact with the nozzle holder 14 at one end in the axial direction and is in contact with the receiving pipe 11 at the other end.

The coil 40 is received in housing 50, as shown in FIGS. 1 and 5. The resin-formed part 45 is formed on the spool 41 of the coil 40. When the coil 40 is received in the housing 50, the ends 521a, 522a opposite to the side portion 53 of the support portions 521 and 522 of the second wall portion 52 can come into contact with the resin-formed part 45 of the coil 40. When the coil 40 is received in the housing 50, the support portion 521 or the support portion 522 is brought into contact with the resin-formed part 45 to prevent the coil 40 and the housing 50 from turning relatively in the peripheral direction. Further, the support portion 521 or the support portion 522 is brought into contact with the resin -formed part 45 to prevent the coil 40 and the housing 50 from moving in the radial direction. That is, the resin-formed part 45 constructs the preventive part as claimed in claims.

In the housing 50, as shown in FIG. 4, the first wall portion 51, the second wall portion 52, and the side portion 53 are integrally formed of a single part without a seam. In the housing 50, for example, by pressing a plate made of a magnetic material, the first opening 54 is formed in the first wall portion 51 and the support portions 521 and 522 are formed in the second wall portion 52. By bending the plate having the first opening 54 and the support portions 521 and 522 formed therein, the plate is formed into the housing 50 of one piece having no seam.

The moving core 32, as shown in FIG. 1, is mounted in t he inner peripheral side of the nozzle holder 14 so as to be able to reciprocate in the axial direction. In the moving core 32, an end opposite to the injection port 23 is opposed to the fixed core 31. The outside wall of the moving core 32 can slide on the inside wall of the nozzle holder 14. The moving core 32 is formed of a magnetic material such as iron in the shape of a cylinder. The end opposite to the abutting portion 25 of the needle 24 is fixed to the inner peripheral side of the moving core 32. The needle 24 is fixed to the moving core 32, for example, by pressing -in or welding. With this, the needle 24 and the moving core 32 reciprocate as one piece in the axial direction. The first wall portion 51 of the housing 50 surrounds the moving core 32 in the peripheral direction across the nozzle holder 14.

The end opposite to the abutting portion 25 of the needle 24 fixed to the inner peripheral side of the moving core 32 is in contact with a spring 15 as an elastic member. One end of the spring 15 is in contact with the needle 24 and the other end is in contact with an adjusting pipe 16. The spring 15 has a force extending in the axial direction. Hence, the needle 24 integrated with the moving core 32 is pressed by the spring 15 in a direction in which it is seated on a valve seat 21. The adjusting pipe 16 is pressed in the fixed core 31. Hence, by adjusting the amount of pressing-in of the adjusting pipe 16, the pressing force of the spring 15 can be adjusted. When the coil 40 is not energized, the moving core 32 and the needle 24 are pressed in the direction of the valve seat 21, whereby the abutting portion 25 is seated on the valve seat 21.

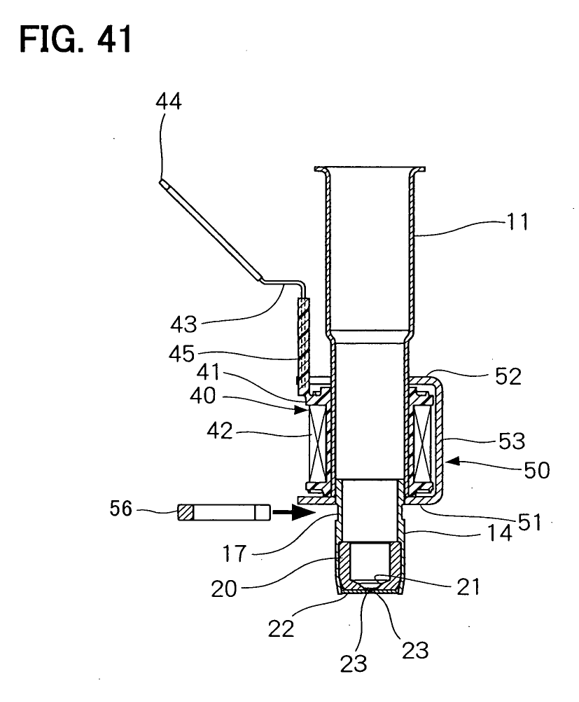

The first wall portion 51 of the housing 50 is in contact with a ring 56 as a holding part. The ring 56 is fitted outside in the radial direction of the nozzle holder 14 on the valve body 20 side of the housing 50. The ring 56, as shown in FIG. 40, is formed in the shape of a letter C in section vertical to the axis. That is, the ring 56 has an arc-shaped annular portion 61 and an opening 62. The nozzle holder 14 has a depression 17 depressed inward in the radial direction, as shown in FIGS. 1, 6, and 41. The ring 56, as shown in FIG. 41, is fitted in the depression 17 from outside in the radial direction of the nozzle holder 14, thereby being fixed to the nozzle holder 14. The surface of the housing 50 side of the ring 56 is brought into contact with the first wall portion 51 of the housing 50 to prevent the movement of the housing 50 and the coil 40 received in the housing 50. This prevents the relative movement in the axial direction of the housing 50 and the coil 40 with respect to the receiving pipe 11 and the nozzle holder 14. The ring 56 is formed of a non-magnetic material, a magnetic material, or resin. The material of the ring 56 is selected according to a portion where it is applied or the holding force of the coil 40.

Next, the mounting of the injector 10 constructed in the manner described above. The coil 40 is received in the inner peripheral side of the housing 50. The coil 40 is received inside the housing 50 from the side of the housing 50. At this time, the second wall portion 52 of the housing 50 is brought into contact with the resin-formed part 45 of the coil 40 to prevent the relative turn in the peripheral direction between the coil 40 and the housing 50 and to prevent the movement to the side portion 53 of the coil 40.

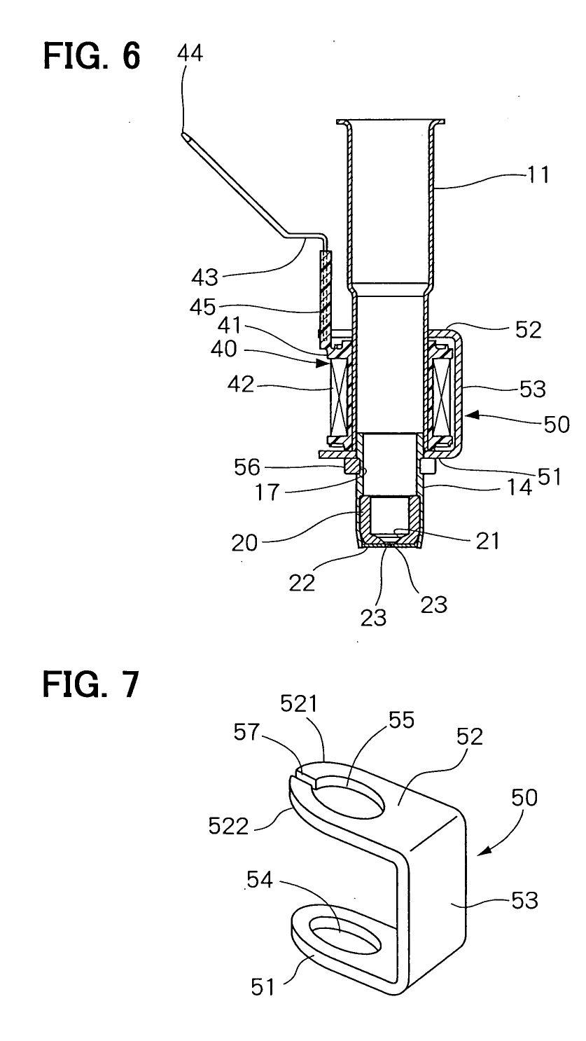

When the coil 40 is mounted in the housing 50, as shown in FIG. 6, the receiving pipe 11 of the internal part is mounted in the housing 50 having the coil 40 received therein. The nozzle holder 14 is connected to the receiving pipe 11. The valve body 20 and the injection port plate 22 may be mounted in the nozzle holder 14. The receiving pipe 11 is inserted into the inner peripheral side of the cylinder-shaped coil 40 and is inserted into the second opening 55 between the support portion 521 and the support portion 522 of the housing 50.

The ring 56, as shown in FIG. 41, is fitted in the depression 17 from outside in the radial direction of the nozzle holder 14. With this, the coil 40 and the housing 50 have the receiving pipe 11 inserted therein and are brought into contact with the ring 56 fitted on the nozzle holder 14 integrated with the receiving pipe 11, thereby being prevented from moving relatively in the axial direction. In the case of this embodiment, the ring 56 is mounted on the first wall portion side of the housing 50. Hence, the coil 40 and the housing 50 are allowed to move upward in FIG. 1 but are prevented from moving downward in FIG. 1. The coil 40 is received in the housing 50. Hence, the coil 40 is brought into contact with the first wall portion 51 or the second wall portion 52, thereby being prevented from moving in the axial direction.

The ring 56 may be fitted on the nozzle holder 14 before the receiving pipe 11 is inserted into the coil 40 and the housing 50 or may be fitted on the nozzle holder 14 after the receiving pipe 11 is inserted into the coil 40 and the housing 50.

After the positions in the axial direction of the coil 40 and the housing 50 with respect to the receiving pipe 11 are determined by the ring 56, a resin mold 33 is molded outside the receiving pipe 11, the coil 40 and the housing 50 placed in a molding die (not shown). The resin mold 33 is molded with the receiving pipe 11, the coil 40, and the housing 50 inserted therein by pouring melted resin into the molding die (not shown). The resin for molding the resin mold 33 is poured from above in FIG. 6, that is, from the opposite side to the nozzle holder 14. Hence, when the resin for molding the resin mold 33 is poured, a pressing force to the nozzle holder 14 is applied to the coil 40 and the housing 50. On the other hand, the housing 50 is brought into contact with the ring 56 at the first wall portion 51. With this, even when the coil 40 and the housing 50 are pressed to the nozzle holder 14 upon pouring of the resin, the movement to the nozzle holder 14 of the coil 40 and the housing 50 is limited.

To insulate the coil 40 from the housing 50, resin is poured also between the coil 40 and the housing 50. In the case of this embodiment, the plate-shaped side portion 53 of the housing 50 is located outside in the radial direction of the coil 40. Hence, the coil 40 comes close to the housing 50 only at one point. Hence, even when the distance between the coil 40 and the housing 50 is made smaller as compared with the case where the coil 40 is surrounded in the peripheral direction in the nearly concentric manner by the housing 50, the resin can be easily poured. By arranging the coil 40 close to the hosing 50, the outside diameter of the injector 10 can be easily made smaller.

When the pouring of the resin forming the resin mold 33 is finished, the needle 24 integrated with the moving core 32 and the fixed core 31 constructing the internal part are mounted in the receiving pipe 11. The fixed core 31 is pressed inside the receiving pipe 11. Further, the spring 15 and the adjusting pipe 16 are mounted in the inner peripheral side of the fixed core 31. Here, these moving core 32, the needle 24, the fixed core 31, the spring 15, and the adjusting pipe 16 may be mounted before the resin forming the resin mold 33 is poured.

In the mounting procedure described above, the mounting of the main parts such as the inserting of the receiving pipe 11 into the housing 50 in which the coil 40 is received, the forming of the resin mold 33, the inserting of the needle 24 and the moving core 32, and the pressing-in of the fixed core 31 can be performed in one direction from the fuel inlet 12 side. Hence, this can simplify a device for mounting the injector 10 and reduce the number of man-hours required to mount the main parts.

Next, the operation of the injector 10 having the above-described construction will be described.

When the passing of current through the coil 40 is stopped, a magnetic attracting force is not generated between the fixed core 31 and the moving core 32. Hence, the moving core 32 is moved to the opposite side of the fixed core 31 by the pressing force of the spring 15. With this, the needle 24 integrated with the moving core 32 is moved to the opposite side of the fixed core 31. As a result, when the passing of current through the coil 40 is stopped, the abutting portion 25 of the needle 24 is seated on the valve seat 21. Hence, the fuel is not injected from the fuel injection port 23.

When the current is passed through the coil 40, a magnetic circuit is formed through the housing 50, the nozzle holder 14, the moving core 32, and the fixed core 31 by a magnetic field generated in the coil 40 to flow magnetic flux. The first wall portion 51 of the housing 50 and the nozzle holder 14 in contact with the first wall portion 51 are formed of magnetic materials, respectively. Hence, the magnetic resistance between the nozzle holder 14 and the housing 50 are small.

The receiving pipe 11 is sandwiched between the second wall portion 52 of the housing 50 and the fixed core 31. When the receiving pipe 11 is formed of a non-magnetic material, the receiving pipe 11 is thin and hence the magnetic flux sufficiently passes between the second wall portion 52 and the fixed core 31. Hence, even when the receiving pipe 11 is formed of the non-magnetic material, the magnetic resistance between the second wall portion 52 and the fixed core 31 can be reduced.

On the other hand, when the receiving pipe 11 is formed of a magnetic material, it is thought that the flux develops a short circuit through the nozzle holder 14 and the fixed core 31 via the receiving pipe 11. However, since the receiving pipe 11 is thin, the magnetic flux developing the short circuit in the receiving pipe 11 is readily saturated. For this reason, even when the receiving pipe 11 is formed of the magnetic material, the short circuit of the magnetic flux via the receiving pipe 11 can be reduced.

In this manner, even when the receiving pipe 11 is formed of either a non-magnetic material or a magnetic material, an increase in the magnetic resistance or the short circuit of the magnetic flux can be reduced. With this, the housing 50, the nozzle holder 14, the moving core 32, and the fixed core 31 form the magnetic circuit through which the magnetic flux flows by the magnetic field generated in the coil 40. As a result, when current is passed through the coil 40, a magnetic attracting force is generated between the fixed core 31 and the moving core 32 that are separated from each other by the pressing force of the spring 15. When the magnetic attracting force generated between the fixed core 31 and the moving core 32 is larger than the pressing force of the spring 15, the moving core 32 integrated with the needle 24 is moved in the direction of the fixed core 31. With this, the abutting portion 25 of the needle 24 is separated from the valve seat 21.

The fuel flowing from the fuel inlet 12 into the injector 10 flows into the fuel passage 26 through the fuel filter 13, the inner peripheral side of the receiving pipe 11, the inner peripheral side of the adjusting pipe 16, the inner peripheral side of the fixed core 31, the inner peripheral side of the moving core 32, the fuel passage 27 in the peripheral side of the needle 24, and a fuel port 28. The fuel flowing into the fuel passage 26 passes between the needle 24, separated from the valve seat 21, and the valve body 20 and flows into the injection port 23 formed in the injection port plate 22. With this, the fuel is injected from the injection port 23.

When the passing of current through the coil 40 is stopped, the magnetic attracting force generated between the fixed core 31 and the moving core 32 ceases to exist. With this, the moving core 32 integrated with the needle 24 is moved to the opposite side of the fixed core 31 by the pressing force of the spring 15. For this reason, the abutting portion 25 is again seated on the valve seat 21 to stop the flow of the fuel between the fuel passage 26 and the injection port 23. Hence, the injection of the fuel is finished.

In the first embodiment described above, the first wall portion 51, the second wall portion 52, and the side portion 53 of the housing 50 are formed as an integrated part having no seam. Further, the first wall portion 51 surrounds the nozzle holder 14 in the peripheral direction. Hence, the magnetic field generated in the coil 40 flows sufficient magnetic flux in the housing 50. Still further, since the first wall portion 51 surrounds the entire periphery of the nozzle holder 14 and the support portions 521, 522 support the receiving pipe 11, the inclination of the receiving pipe 11 and the nozzle holder 14 can be reduced. Still further, the cutout 551 is formed between the support portions 521 and 522. With this, the second opening 55 formed between the support portions 521 and 522 can be expanded or contracted in the radial direction. Hence, the inclination or dimensional error of the receiving pipe 11 of the internal part can be absorbed by the expansion or contraction of the distance between the support portions 521 and 522 forming the second opening 55. Hence, the positional relationship between the receiving pipe 11, the nozzle holder 14, and the housing 50 can be secured with precision to increase with stability the magnetic attracting force generated between the fixed core 31 and the moving core 32.

Further, in this embodiment, the support portions 521, 522 of the housing 50 is brought into contact with the resin -formed part 45 of the coil 40 to prevent the relative turn in the peripheral direction between the coil 40 and the housing 50 and the movement to the side portion 53 of the coil 40. This can prevent the incorrect positional relationship between the coil 40 and the housing 50 and prevent the winding 42 or the wiring part 43 of the coil 40 through which current flows from being brought into contact with the housing 50 of a conductive part. For this reason, when the resin molding the resin mold 33 is poured, the positional relationship between the coil 40 and the housing 50 is not changed. Further, the resin-formed part 45 of the coil 40, brought into contact with the support portions 521, 522 of the housing 50, is a part that the coil 40 is originally provided with so as to support to the wiring part 43. For this reason, the resin-formed part 45 of the coil 40 is easily mounted in a manner integrated with the spool 41 and does not cause a complex structure. Hence, the positional relationship between the coil 40 and the housing 50 can be determined with precision without causing the complex structure of the coil 40 and the housing 50. Further, this can increase and stabilize the magnetic attracting force developed between the fixed core 31 and the moving core 32 by the magnetic field generated by the coil 40. Hence, the injector 10 of the first embodiment can improve the responsivity of operation of the needle 24.

Further, in the first embodiment, even when the coil 40 is arranged close to the housing 50, the resin can be easily poured between the coil 40 and the housing 50. With this, the coil 40 can be arranged close to the housing 50 and hence the injector 10 can be reduced in outside diameter. In recent years, the integration of peripheral parts of the engine advances and makes it difficult to secure sufficient space around an intake pipe when the injector 10 is mounted in the intake pipe connected to the combustion chamber of the engine. On the other hand, by reducing the outside diameter of the injector 10, it is easy to secure space for mounting the injector 10. Further, when the injector 10 is applied to a direct injection type engine, the injector 10 is mounted on a cylinder head. Hence, by reducing the outside diameter of the injector 10, a hole to be formed in the cylinder head can be made small. This can easily secure a sealing ability. Therefore, by reducing the outside diameter of the injector 10, the degree of flexibility in the design of peripheral parts of the engine can be enhanced.

Still further, in the first embodiment described above, the ring 56 fitted on the nozzle holder 14 prevents the relative movement of the coil 40 and the housing 50 to the receiving pipe 11. For this reason, when the resin forming the resin mold 33 is poured, the coil 40 and the housing 50 do not move in the axial direction relatively to the receiving pipe 11. Further, the second wall portion 52 of the housing 50 is brought into contact with the base portion 45 of the coil 40 to prevent the relative movement in the peripheral direction between the coil 40 and the housing 50. For this reason, the positional relationship in the peripheral direction between the coil 40 and the housing 50 is not changed. Hence, the positions of the coil 40 and the housing 50 can be determined with respect to the receiving pipe 11.

### Second Embodiment

The housing of an injector in accordance with the second embodiment is shown in FIG. 7. The substantially same constituent parts as those in the first embodiment are denoted by the same reference symbols and their descriptions will be omitted.

In the second embodiment, as shown in FIG. 7, in the portions of the first wall portion 51 and the second wall portion 52 of the housing 50, the edge portions outside in the radial direction are formed nearly concentrically with the first opening 54 of the first wall portion 51. The second wall portion 52 has a cutout 57 on the side opposite to the side portion 53 of the second opening 55. For this reason, the support portions 521 and 522 of the second wall portion 52 face each other across the cutout 57. By forming the cutout 57, the distance between the support portion 521 and the support portion 522 can be expanded or contracted. Since the distance between the support portion 521 and the support portion 522 can be expanded or contracted, when the receiving pipe 11 is inclined in the axial direction, the inclination can be absorbed by the expansion and contraction of the distance between the support portion 521 and the support portion 52.

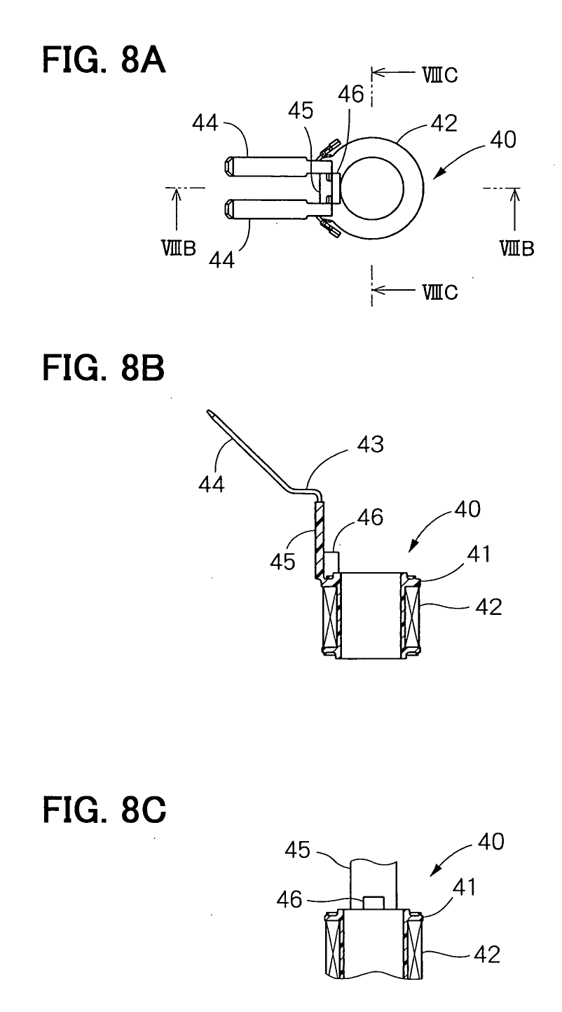

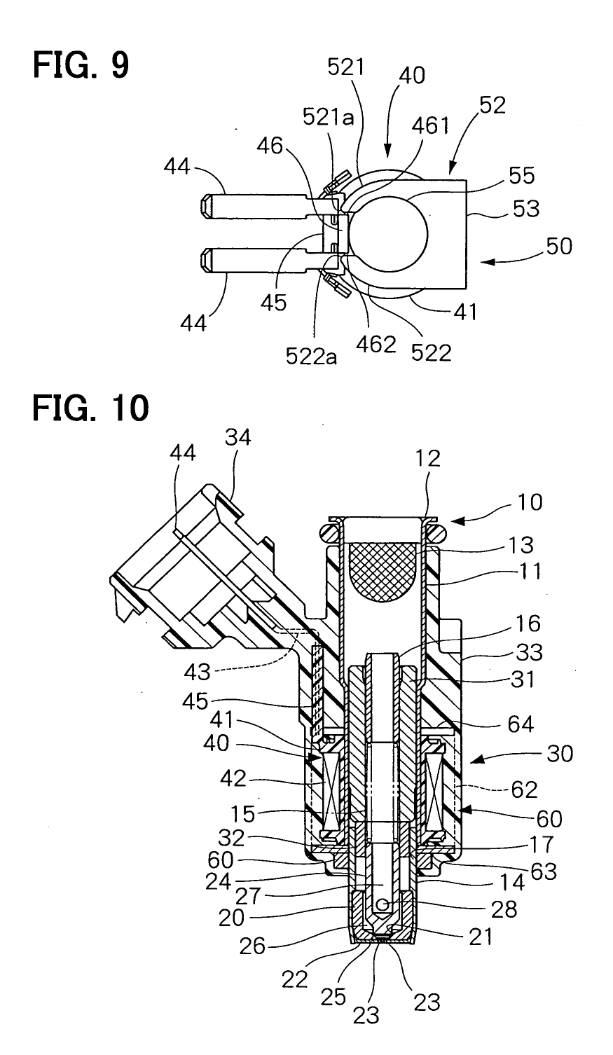

Further, in the second embodiment, as shown in FIGS. 8A to 8C, the coil 40 has a preventive part 46 protruding inward in the radial direction from the resin-formed part 45. The preventive part 46 is formed of the same resin integrally with the spool 41 and the resin-formed part 45. The length in the peripheral direction of the preventive part 46, as shown in FIG. 7, is set at a smaller value than the distance between the support portions 521 and 522 of the housing 50. With this, as shown in FIG. 9, when the coil 40 is received in the housing 50, the preventive part 46 is arranged between the support portions 521 and 522 of the housing 50. When the coil 40 and the housing 50 turn relatively to each other in the peripheral direction, the end portion 461 or the end portion 462 in the peripheral direction of the preventive part 46 is brought into contact with the support portion 521 or the support portion 522. When the preventive part 46 is brought into contact with the support portion 521 or the support portion 522, the relative turn in the peripheral direction between the coil 40 and the housing 50 are prevented. Further, when the end portion 521 a or 522a opposite to the side portion 53 of the support portion 521 or the support portion 522 is brought into contact with the resin-formed part 45 of the coil 40, the coil 40 is prevented from moving inward in the radial direction of the housing 50.

In the second embodiment, the expansion or contraction of the distance between the support portion 521 and the support portion 522 absorbs the inclination of the receiving pipe 11. Hence, the inclination of the receiving pipe 11 can be reduced. Further, in the second embodiment, the relative turn in the peripheral direction between the coil 40 and the housing 50 is prevented by the preventive part 46 provided on the coil 40. The preventive part 46 is formed integrally with the spool 41 of the coil 40 and the resin-formed part 45. Hence, this can determine the positional relationship between the coil 40 and the housing 50 with precision without causing the complex structure of the coil 40 and the housing 50.

### Third Embodiment

An injector in accordance with the third embodiment of the invention is shown in FIG. 10. The substantially same constituent parts as those in the first embodiment are denoted by the same reference symbols and their descriptions are omitted.

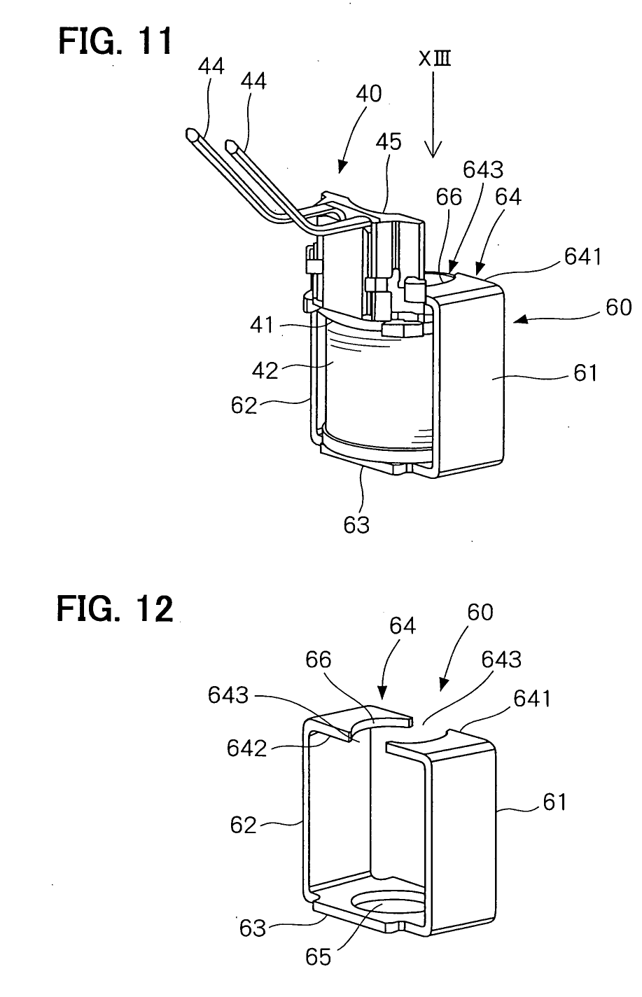

In the third embodiment, as shown in FIG. 10 and FIG. 11, a housing 60 is arranged in a state where it turns 90 degree in the peripheral direction with respect to the coil 40 as compared with the first embodiment. As shown in FIG. 12, the housing 60 includes the first side portion 61, the second side portion 62, the first wall portion 63, and the second wall portion 64. The first side portion 61 and the second side portion 62 are nearly parallel to the axis of the coil 40. That is, as shown in FIG. 11, the coil 40 is covered with the first side portion 61 and the second portion 62 of the housing 60 at both end portions in the radial direction. The first side portion 61 and the second side portion 62 face each other across the coil 40 at both end portions in the radial direction of the coil 40. The first wall portion 63 is connected to the ends opposite to the second wall portion 64 of the first side portion 61 and the second side portion 62. The first wall portion 63 has in the center the first opening 65 through which the nozzle holder 14 as a cylindrical part of an internal part is passed. The nozzle holder 14 is arranged in the first opening 65 of the first wall portion 63, thereby being surrounded around the entire periphery in the peripheral direction by the first wall portion 63 of the housing 60. That is, the first wall portion 63 forms a surrounding part surrounding the entire periphery of the nozzle holder 14 in the peripheral direction.

The housing 60 has the first protruding portion 641 protruding from the first side portion 61 to the second side portion 62 and the second protruding portion 642 protruding from the second side portion 62 to the first side portion 61 at the end opposite to the first wall portion 63. The first protruding portion 641 and the second protruding portion 642 construct the second wall portion 64. The first protruding portion 641 and the second protruding portion 642 form in the center the second opening 66 in which the receiving pipe 11 is received. The first protruding portion 641 and the second protruding portion 642 are opposed to each other a predetermined gap apart. With this, the second opening 66 is open to the outer peripheral edge of the second wall portion 62 via a cutout 643. In the housing 60, the second wall portion 64 including the first protruding portion 641 and the second protruding portion 642, the first side portion 61, the first wall portion 63, and the second side portion 62 are integrally formed without a seam by working one plate.

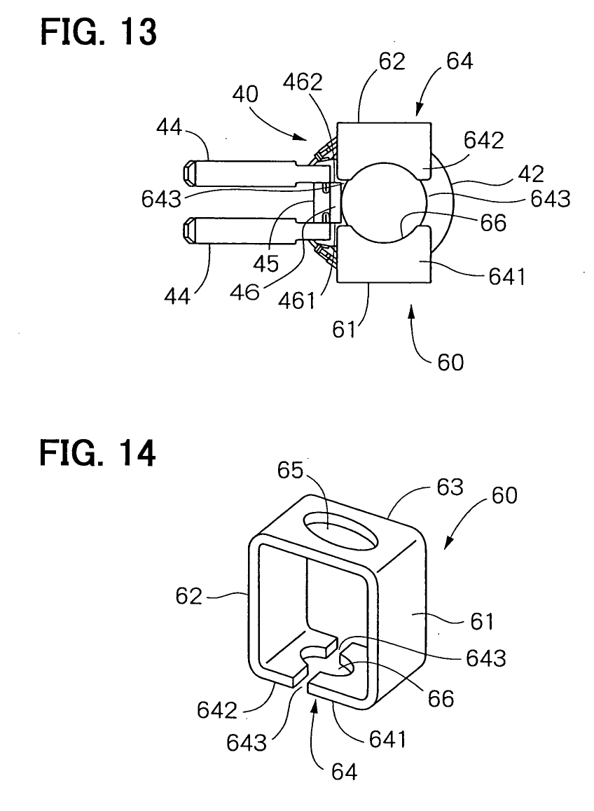

The coil 40 is constructed in the same manner as in the second embodiment. In the case of the third embodiment, the preventive part 46 of the coil 40, as shown in FIG. 13, is arranged between the first protruding portion 641 and the second protruding portion 642 of the housing 60. In the preventive part 46 of the coil 40, when the coil 40 and the housing 60 are turned relatively in the peripheral direction, an end 461 or an end 462 in the peripheral direction is brought into contact with either the first protruding portion 641 or the second protruding portion 642. The preventive part 46 is brought into contact with the first protruding portion 641 or the second protruding portion 642 to prevent the relative turn in the peripheral direction between the coil 40 and the housing 60. Further, the housing 60 is brought into contact with the resin-formed part 45 of the coil 40 to prevent the coil 40 from moving inward in the radial direction of the housing 60.

In the third embodiment, a cutout 643 is formed between the first protruding portion 641 and the second protruding portion 642. With this, the second opening 66 formed between the first protruding portion 641 and the second protruding portion 642 can be expanded or contracted in the radial direction. Hence, the inclination or the dimensional error of the receiving pipe 11 of an internal part is absorbed by the expansion of contraction of the distance between the first protruding portion 641 and the second protruding portion 642 forming the second opening 66. Therefore, the positional relationship between the receiving pipe 11, the nozzle holder 14, and the housing 50 is secured with precision, whereby the magnetic attracting force developed between the fixed core 31 and the moving core 32 can be increased with stability.

In the third embodiment, the preventive part 46 of the coil 40 is arranged between the first protruding portion 641 and the second protruding portion 642 to prevent relative turn in the peripheral direction between the coil 40 and the housing 60. Hence, the positional relationship between the coil 40 and the housing 60 can be determined with precision without causing the complex structure of the coil 40 and the housing 60.

Further, in the third embodiment, in the housing 60, the first side portion 61 and the second side portion 62 cover the coil 40 at both ends in the radial direction of the coil 40. For this reason, the flow of magnetic flux is made-uniform at both ends in the radial direction of the coil 40. Further, since the housing 60 has the first side portion 61 and the second side portion 62, the housing 60 is increased in strength to load in the axial direction and in the radial direction. This prevents the receiving pipe 11, the coil 40, and the housing 60 from being deformed, thereby keeping with precision the positional relationship between the receiving pipe 11, the coil 40, and the housing 60. Therefore, this can stabilize and increase the magnetic attracting force developed between the fixed core 31 and the moving core 32.

### Fourth Embodiment

An injector in accordance with the fourth embodiment of the invention is shown in FIG. 14. The substantially same constituent parts as those in the third embodiment are denoted by the same reference symbols and their descriptions are omitted.

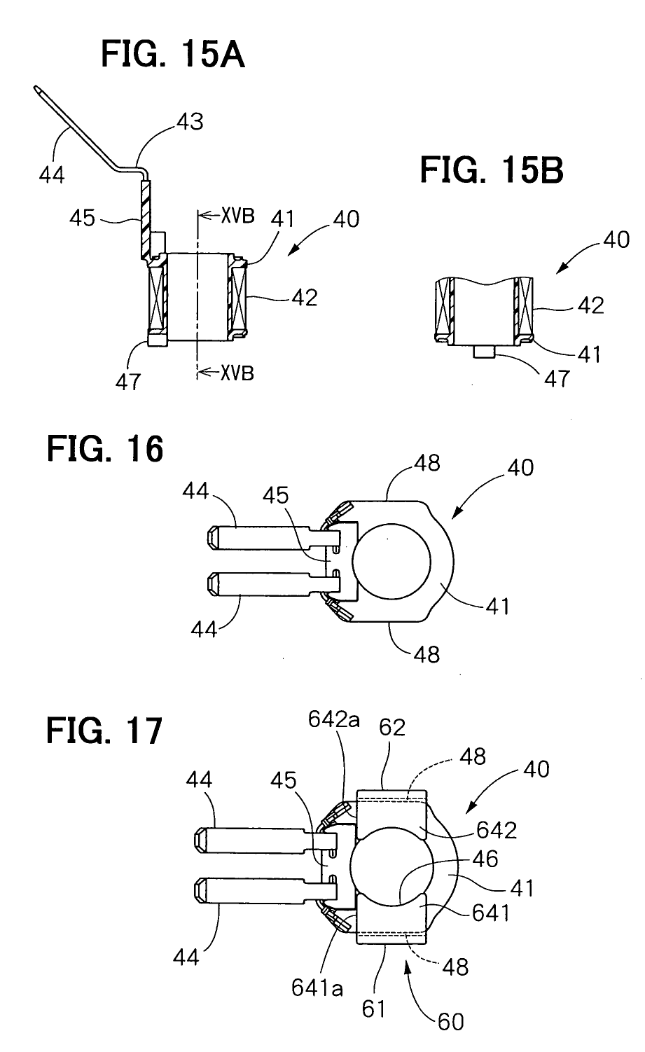

In the fourth embodiment, as shown in FIG. 14, the housing 60 is mounted in a manner inverted in the axial direction with respect to the third embodiment shown in FIG. 12. That is, the first wall portion 63 of the housing 60 is located on the resin-formed part 45 side of the coil 40 and the second wall portion 64 is located opposite to the resin-formed part 45 of the coil 40. A preventive part 47 is mounted between the first protruding portion 641 and the second protruding portion 642 of the second wall portion 64. For this reason, as shown in FIGS. 15A and 15B, the coil 40 has the preventive part 47 on the end opposite to the resin-formed part 45 of the spool 41. With this, the preventive part 47 is mounted between the first protruding portion 641 and the second protruding portion 642 of the second wall portion 64.

In the fourth embodiment, as is the case with the third embodiment, the magnetic flux is made uniform at both ends in the radial direction of the coil 40. Further, the housing 60 is increased in strength to load in the axial direction and in the radial direction to reduce the deformation of the receiving pipe 11. Hence, this can stabilize and increase the magnetic attracting force developed between the fixed core 31 and the moving core 32.

Further, the housing 60 can be freely mounted according to the injector 10 applied thereto as shown in the third embodiment and the fourth embodiment. On the other hand, the preventive part of the coil 40 can be freely mounted according to the shape of the housing 60. Therefore, the degree of flexibility in the design of the housing 60, the coil 40, and the injector 10 can be increased.

### Fifth Embodiment

The driving unit of an injector in accordance with the fifth embodiment of the invention is shown in FIG. 16. The substantially same constituent parts as those in the third embodiment are denoted by the same reference symbols and their descriptions are omitted.

In the fifth embodiment, as shown in FIG. 16, the cylindrical spool 41 has plane portions 48 on the outside wall. The plane portions 48 are formed on both ends in the radial direction of the spool 41 and are nearly parallel to the surfaces on the coil 40 side of the first side portion 61 and the second side portion 62 of the housing 60. When the spool 41 is received in the housing 60, as shown in FIG. 17, the plane portions 48 of the spool 41 are supported by the surfaces on the coil 40 side of the first side portion 61 and the second side portion 62. Hence, the plane portions 40 are brought into contact with the first side portion 61 or the second side portion 62 to prevent the relative turn in the peripheral direction between the coil 40 and the housing 60. Since the spool 41 is formed of resin, the plane portions 48 can be easily formed. Therefore, the positional relationship between the coil 40 and the housing 60 can be determined with precision without causing the complex structure of the coil 40 and the housing 60. Further, in the fifth embodiment, the edge 641a of the first protruding portion 641 of the housing 60 and the edge 642a of the second protruding portion 642 are brought into contact with the resin-formed part 45 to prevent the coil 40 from moving inwardly in the radial direction of the housing 60.

### Sixth Embodiment

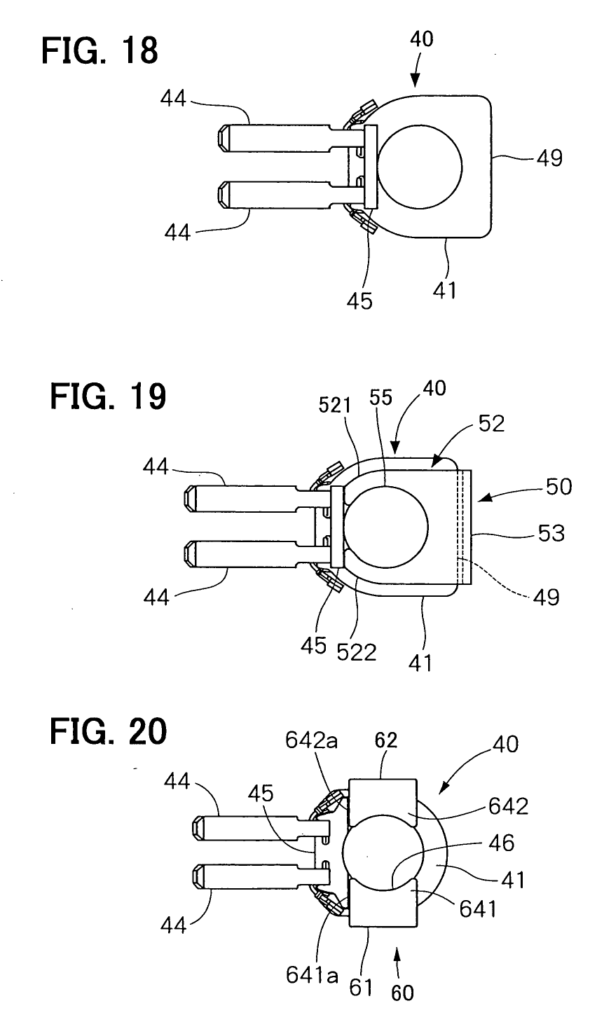

The driving unit of an injector in accordance with the sixth embodiment of the invention will be described in FIG. 18 and FIG. 19.

In the sixth embodiment, the housing 50 is formed in the same shape as in the second embodiment, as shown in FIG. 18. Hence, the description of the housing 50 will be omitted. In the sixth embodiment, as shown in FIG. 19, the positional relationship between the coil 40 and the housing 50 is the same as in the second embodiment.

In the sixth embodiment, the cylindrical spool 41 has a plane portion 49 on the outside wall. Further, the plane portion 49 is formed on the end opposite to the resin-formed part 45 of the spool 41, which is different from the fifth embodiment. The plane portion 49 is nearly parallel to the surface on the coil 40 side of the side portion 53 of the housing 50. When the spool 41 is received in the housing 50, as shown in FIG. 19, the plane portion 49 of the spool 41 is brought into contact with the surface on the coil 40 side of the side portion 53. The plane portion 49 is brought into contact with the side portion 53 to prevent the relative turn in the peripheral direction between the coil 40 and the housing 50. Since the spool 41 is formed of resin, the plane portion 49 can be easily formed. Hence, the positional relationship between the coil 40 and the housing 50 can be determined with precision without causing the complex structure of the coil 40 and the housing 50. Further, in the sixth embodiment, the support portion 521 and the support portion 522 of the housing 50 are brought into contact with the resin-formed part 45 of the coil 40 to prevent the coil 40 from moving inward in the radial direction of the housing 50.

### Seventh Embodiment

The driving unit of an injector in accordance with the seventh embodiment of the invention is shown in FIG. 20. The substantially same constituent parts as those in the third embodiment are denoted by the same reference symbols and their descriptions are omitted.

In the seventh embodiment, as shown in FIG. 20, the resin-formed part 45 is formed in a manner extending in the radial direction. The resin-formed part 45 is nearly parallel to the edge 641 a of the first protruding portion 641 and the edge 642a of the second protruding portion 642 of the housing 60. When the coil 40 is received in the housing 60, the resin-formed part 45 is brought into contact with the edge 641a of the first protruding portion 641 and the edge 642a of the second protruding portion 642. With this, the relative turn in the peripheral direction between the coil 40 and the housing 60 is prevented. Hence, the positional relationship between the coil 40 and the housing 60 can be determined with precision without causing the complex structure of the coil 40 and the housing 60.

### Eighth Embodiment

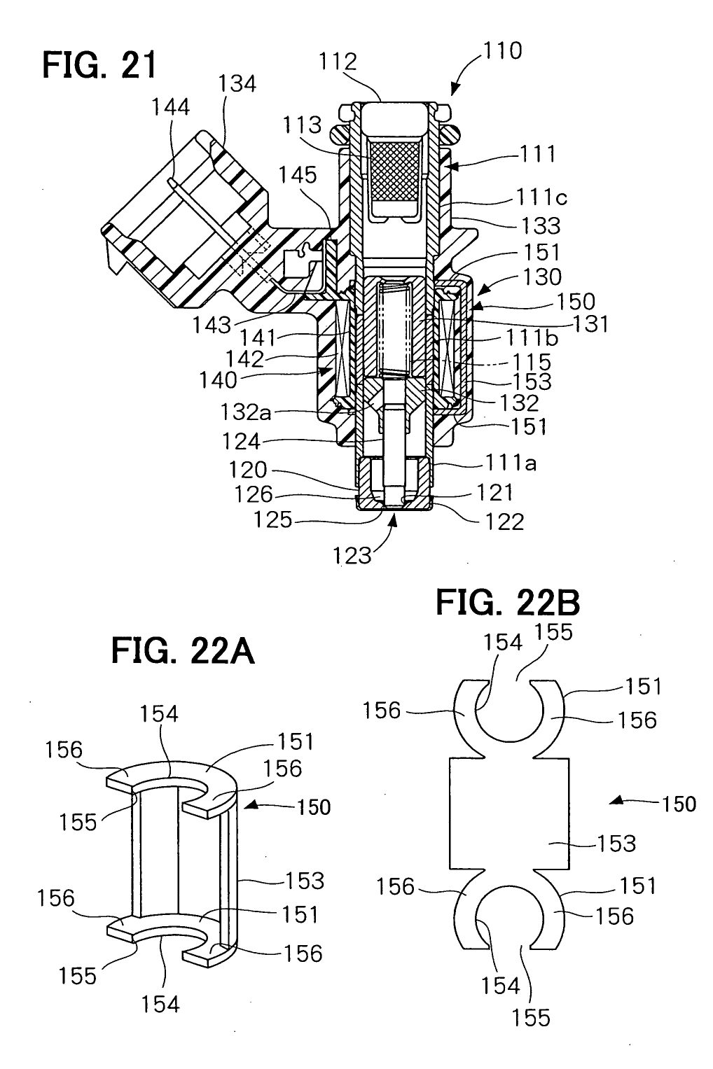

An injector in accordance with the eighth embodiment of the invention is shown in FIG. 21.

In the eighth embodiment, the construction of an injector 110 is different from those in the first embodiment to the seventh embodiment. Hence, a brief description of the construction of the injector 110 will be provided. The receiving pipe 111 of the injector 110 is formed nearly in the shape of a cylinder having a thin thickness. The receiving pipe 111 has the first magnetic part 111a, a non-magnetic part 111b, and the second magnetic part 111c. The first magnetic part 111a, the non-magnetic part 111b, and the second magnetic part 111c are connected to each other, for example, by laser welding or the like, thereby being integrated into one piece. Here, it is also recommended that the receiving pipe 111 be integrally formed of a magnetic material and that a portion corresponding to the non-magnetic part 111b be made non-magnetic by heating or the like. The non-magnetic part 111b prevents the magnetic short circuit between the first magnetic part 111a and the second magnetic part 111 c. The receiving pipe 111 has a fuel inlet 112 at one end in the axial direction. The fuel is supplied to the fuel inlet 112 from a fuel pump (not shown). The fuel supplied to the fuel inlet 112 passes through a fuel filter 113 and flows into the inner peripheral side of the receiving pipe 111.

A valve body 120 is mounted at the end opposite to the fuel inlet 112 of the receiving pipe 111, that is, in the inner peripheral side of the first magnetic part 111a. The valve body 120 is formed nearly in the shape of a cylinder and is fixed in the inner peripheral side of the first magnetic part 111a. The valve body 120 has a valve seat 121 on a conical inside wall whose inside diameter becomes smaller as a position comes closer to a tip. The valve body 120 has an injection port plate 122 at the end opposite to the receiving pipe 111. The injection port plate 122 has an injection port that connects an end surface on the valve body 120 side and an end surface opposite to the valve body 120.

A needle 124 as a valve part is received in the inner peripheral side of the first magnetic part 111a and the valve body 120 in such a way as to reciprocate in the axial direction. The needle 124 is arranged nearly coaxially with the receiving pipe 111 and the valve body 120. The needle 124 has an abutting portion 125 near the end on the injection port plate 122 side. The abutting portion 125 can be brought into contact with a valve seat 121 formed on the valve body 120. The needle 124 forms a fuel passage 126 between itself and the valve body 120. The fuel passage 126 is connected to the injection port 123 when the abutting portion 125 of the needle 124 is separated from the valve seat 121. In this embodiment, the needle 124 is formed into a solid column. Here, the needle 124 may be formed in the shape of a cylinder like the plurality of embodiments.

The injector 110 is provided with a driving unit 130 as an electro-magnetic driver for driving the needle 124. The driving unit 130 has a coil 140, a fixed core 131, a housing 150 as a magnetic part, and a moving core 132. The driving unit 130 is constructed of the receiving pipe 111 of a cylindrical part in addition to the coil 140, the fixed core 131, the housing 150, and the moving core 132. The coil 140 has a spool 141 and a winding 142. The spool 141 is formed of resin in the shape of a cylinder. The winding 142 is wound around the outer peripheral side of the spool 141. The coil 140 has a wiring part 143 connected to the winding 142 and a terminal 144 connected to an end opposite to the winding 142 of the wiring part 143. The spool 141 has a resin-formed part 145 protruding to one end in the axial direction. The resin-formed part 145, which has the wiring part 143 connected to the winding 142 inserted therein, and the spool 141 are integrally formed of resin. The receiving pipe 111 is inserted into the inner peripheral side of the cylindrical spool 141. With this, the coil 140 is mounted on the outer peripheral side of the receiving pipe 111.

The fixed core 131 is mounted in the inner peripheral side of the coil 140 across the receiving pipe 111. The fixed core 131 is formed of a magnetic material, for example, electro -magnetic soft iron in the shape of a cylinder. The outer peripheral side of the coil 140, housing 150, and the receiving pipe 111 is covered with resin mold 133. The winding 142 of the coil 140 is electrically connected to the terminal 144 via the wiring part 143. The terminal 144 is mounted in a connector 134. The connector 134 is formed integrally with the resin mold 133. The receiving pipe 111 and the fixed core 131 as the cylindrical part constructs an internal part as claimed in claims. Here, when the internal part is inserted in the inner peripheral side of the coil 140, for example, a moving coil or a needle, the internal part is not necessarily limited to the receiving pipe 111 and the fixed core 131 as described in this embodiment.

The moving core 132 is mounted in the inner peripheral side of the receiving pipe 111 in such a way as to reciprocate in the axial direction. In the moving core 132, an end opposite to the injection port 123 is opposed to the fixed core 131. The outside wall of the moving core 132 can slide on the inside wall of the receiving pipe 111. The moving core 132 is formed of a magnetic material, for example, electromagnetic soft iron nearly in the shape of a cylinder. In the moving core 132, an end opposite to the abutting portion 125 of the needle 124 is fixed to the inner peripheral side. The needle 124 and the moving core 132 are fixed to each other, for example, by pressing-in or welding. With this, the needle 124 and the moving core 132 reciprocate as one piece in the axial direction. A fuel port 132a through which the fuel flows is formed in the moving core 132.

An end opposite to the needle 124 of the moving core 132 is in contact with a spring 115 as an elastic part. The spring 115 is received in the inner peripheral side of the fixed core 131. One end of the spring 115 is in contact with the needle 124 and the other end is in contact with the fixed core 131. The spring 115 has a force extending in the axial direction. For this reason, the needle 124 integrated with the moving core 132 is pressed by the spring 115 in a direction in which the needle 124 is seated on a valve seat 121. An end opposite to the moving core 132 of the fixed core 131 protrudes inward in the radial direction. The spring 115 is retained by this protruding portion of the fixed core 131. Hence, the total length of the spring 115 is changed by adjusting the amount of bending of the end opposite to the moving core 132 of the fixed core 131. As a result, the pressing force of the spring 115 is adjusted. When current is not passed through the coil 140, the moving core 132 and the needle 124 is pressed onto the valve seat 121 and hence the abutting portion 125 is seated on the valve seat 121.

Next, the housing 150 will be described in detail.

The housing 150 is formed of a magnetic material and covers both ends in the axial direction and the outside in the radial direction of the coil 140. The housing 150 has wall portions 151 and a side portion 153, as shown in FIGS. 22A and 22B. The side portion 153 extends in the axial direction outside in the radial direction of the coil 140. With this, the side portion 153 covers a portion in the peripheral direction outside in the radial direction of the coil 140. The wall portions 151 are connected to both ends in the axial direction of the side portion 153 in such a way as to protrude to the inner peripheral side, respectively. With this, the housing 150 is shaped nearly like a letter “C” in section along the axis, as shown in FIG. 21.

Each of the wall portions 151 of the housing 150 has an opening 154, through which the receiving pipe 111 is inserted, in the center. Each of the wall portions 151 has a cutout 155 extending from the opening 154 to the outside edge. Hence, the opening 154 is open to the outside of the wall portion 151. With this, each of the wall portions 151 has support portions 156 for supporting the end portions in the radial direction of the receiving pipe 111 across the opening 154 and the cutout 155. The support portions 156 forming the opening 154 are brought into contact with the receiving pipe 111. Hence, the housing 150 is brought into contact with the receiving pipe 111 at both ends in the axial direction thereof. The spacing of the cutout 155 formed by the support portions 156 can be arbitrarily set.

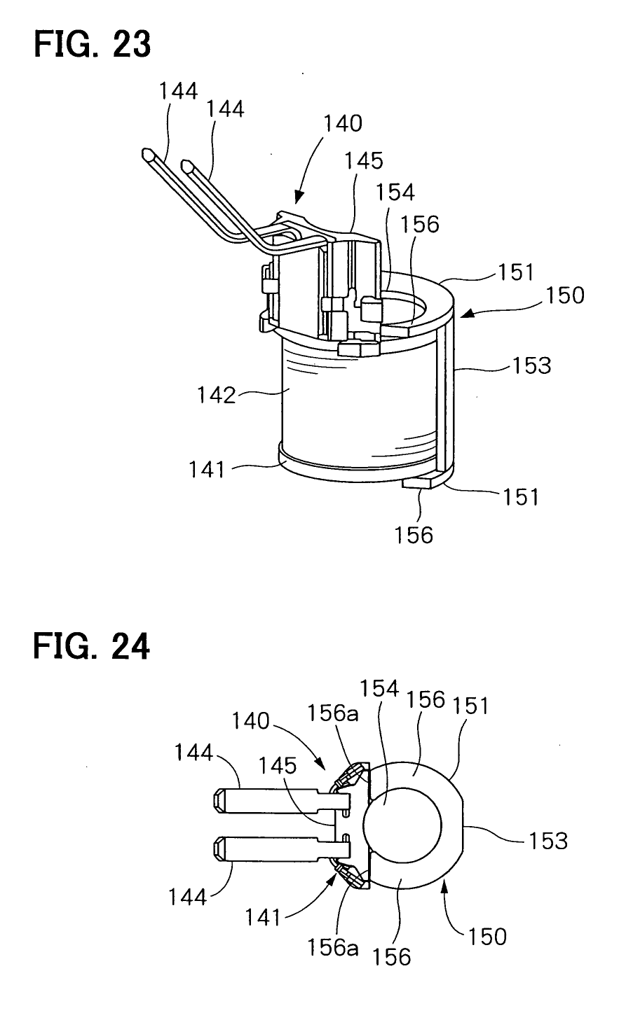

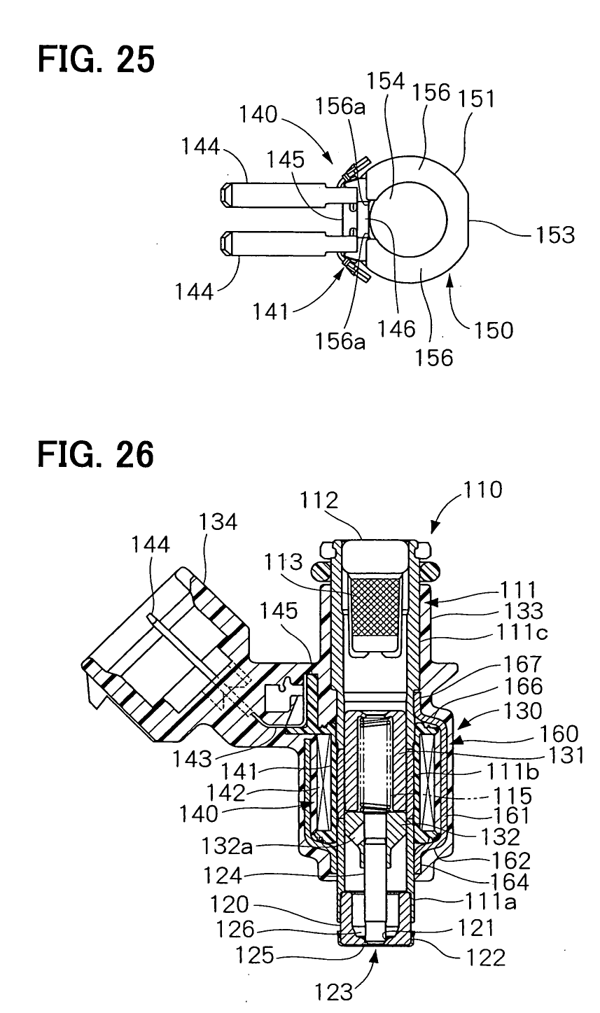

The coil 140 is received inside the housing 150, as shown in FIG. 23 and FIG. 24. The resin-formed part 145 is formed on the spool 141 of the coil 140. When the coil 140 is received in the housing 150, the ends 156a opposite to the side portion 153 of the support portions 156 can be brought into contact with the resin-formed part 145 of the coil 140. When the coil 140 is received in the housing 150, the support portions 156 are brought into contact with the resin-formed part 145 of the coil 140 to prevent the relative turn in the peripheral direction between the coil 140 and the housing 150. Further, the support portions 156 are brought into contact with the resin-formed part 145 of the coil 140 to prevent the coil 140 from moving inward in the radial direction of the housing 150. That is, the resin -formed part 145 constructs a preventive part. Here, the coil 140, as shown in FIG. 25, may have a preventive part 146 protruding inward in the radial direction from the resin-formed part 145 as is the case with the second embodiment described above.

In the housing 150, as shown in FIG. 22, the wall portions 151 and the side portion 153 are integrally formed of a single part without a seam. The housing 150 is formed in a developed shape having the openings 154 and the support portions 156 as shown in FIG. 22B by pressing a plate made of, for example, a magnetic material. Then, by bending portions where two wall portions 151 are connected to the side portion 153 at nearly right angle, an integrated housing 150 having no seam is formed as shown in FIG. 22A. At this time, as shown in FIG. 22A, by bending the side portion 153 in the shape of an arc along the outer peripheral edges of the wall portions 151, the housing 150 is formed nearly in the shape of a cylinder. With this, the distance between the coil 140 and the housing 150 is made uniform in the peripheral direction. Hence, in the housing 150, the magnetic flux effectively flows and hence the magnetic attracting force increases. Further, since the housing 150 is formed nearly in the shape of a cylinder, the resin mold 133 can be easily molded and hence the number of manufacturing man-hours can be reduced.

In the eighth embodiment, the wall portions 151 arranged at both ends in the axial direction of the housing 150 have the cutouts 155, respectively. In this manner, since the cutouts 155 are formed in the two wall portions 151, respectively, the top and bottom ends of the housing are symmetric in the shape. Hence, in the eighth embodiment, in addition to the effect described in the first embodiment, the shape of the housing 150 can be more simplified and hence the shape can be easily controlled. Further, as described above, the housing 150 can cover the outer peripheral side of the coil 140 in the shape of an arc. Therefore, this can stabilize the flow of the magnetic flux and increase the developed magnetic attracting force.

### Ninth Embodiment

An injector in accordance with the ninth embodiment of the invention is shown in FIG. 26. Here, the substantially same parts as those in the eighth embodiment are denoted by the same reference symbols and their descriptions are omitted.

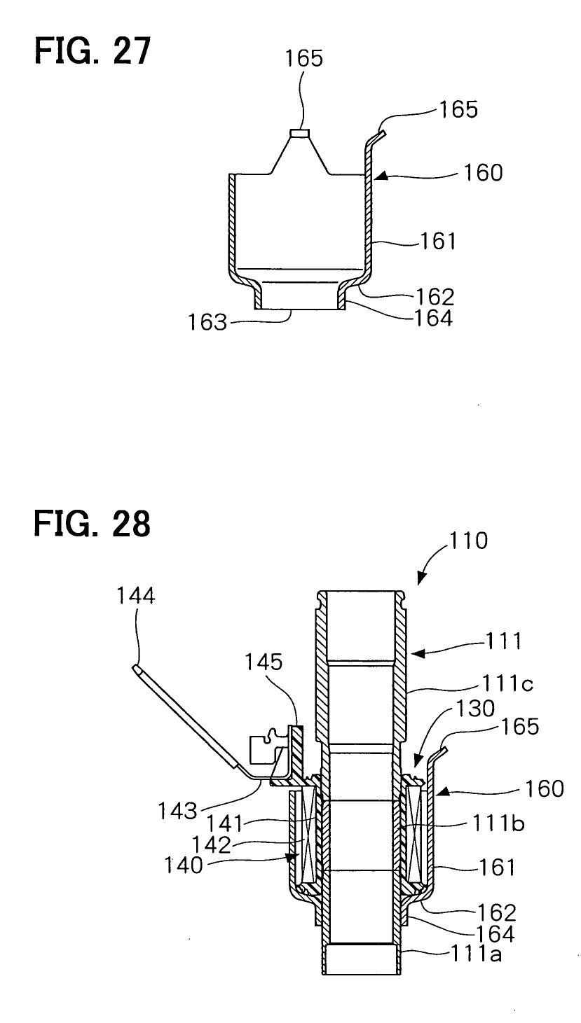

In the ninth embodiment, the shape of a housing 160 is different from those of the plurality of embodiment described above. The housing 160 is formed nearly in the shape of a cylinder and has a cylindrical portion 161 as shown in FIG. 27. The cylindrical portion 161 covers the entire periphery in the peripheral direction on the outer peripheral side of the coil 140. The housing 160 has the first wall portion 162 at one end of the cylindrical portion 161, that is, at one end on the injection port 123 side. The first wall portion 162 is formed along the entire periphery in the peripheral direction like the cylindrical portion 161. With this, the first wall portion 162 forms a surrounding portion 162a surrounding the receiving pipe 111 along the entire periphery in the peripheral direction on the outer peripheral side thereof. Here, the cylindrical portion 161 and the first wall portion 162 may cover at least a portion of the outer peripheral side of the coil 140. That is, the cylindrical portion 161 and the first wall portion 162 may have a cutout in at a portion in the peripheral direction.

The first wall portion 162 forms an opening 163 in the inner peripheral side. The receiving pipe 111 is inserted into this opening 163. The end in the inner peripheral side of the first wall portion 162 forming the opening 163 is in contact with the receiving pipe 111. In this embodiment, the housing 160 has a small-diameter portion 164 extending from the first wall portion 162 to the opposite side of the cylindrical portion 161. The small-diameter portion 164 has an inside diameter nearly equal to the outside diameter of the receiving pipe 111 and hence its inner peripheral wall is in contact with the receiving pipe 111. Since the end of the inner peripheral side of the first wall portion 162 and the small-diameter portion 164 are brought into contact with the receiving pipe 111, the housing 160 is magnetically connected to the first magnetic portion 111a of the receiving pipe 111.

The housing 160 has a protruding portion 165 at the end opposite to the first wall portion 162 of the cylindrical portion 161. The protruding portion 165 is so formed as to extend from the end opposite to the first wall portion 162 of the cylindrical portion 161. As for the protruding portion 165, a plurality of protruding portions are provided in the peripheral direction of the housing 160. The cylindrical portion 161, the first wall portion 162, the small-diameter portion 164, and the protruding portion 165 of the housing 160 are integrally formed of a single part without a seam, for example, by drawing or pressing. The protruding portion 165 is formed so as to extend along the extension of the cylindrical portion 161 or outward in the radial direction before the housing 160 is mounted on the receiving pipe 111.

When the housing 160 is mounted on the receiving pipe 111, as shown in FIG. 28, the coil 140 is mounted in advance on the receiving pipe 111. The housing 160 is mounted on the receiving pipe 111 mounted with the coil 140. The housing 160 is mounted on the receiving pipe 111, for example, from the end of the receiving pipe 111, that is, from the end on the first magnetic portion 111a side.

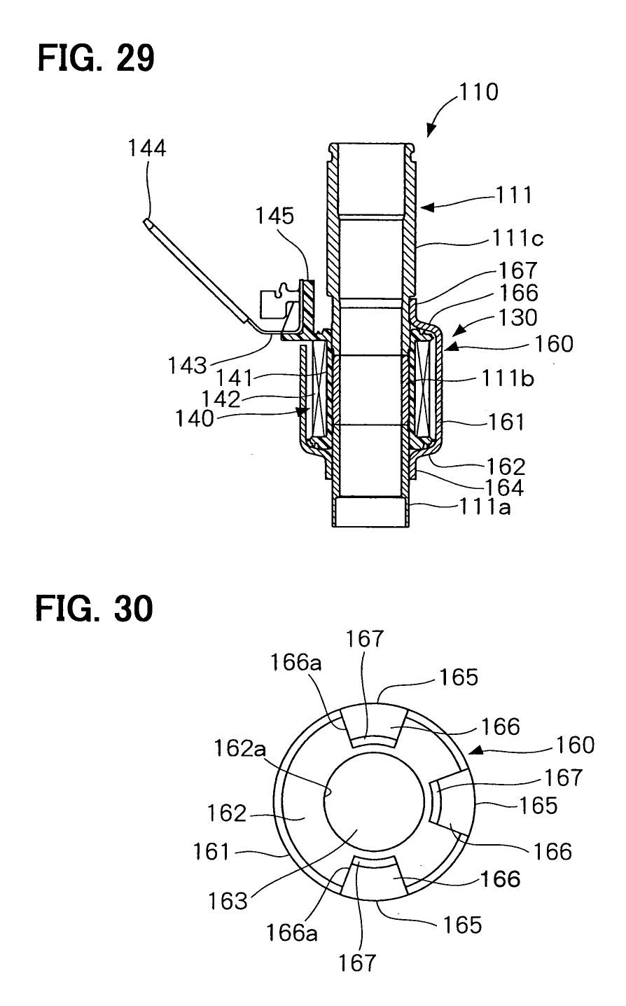

The protruding portion 165 of the housing 160 mounted on the receiving pipe 111, as shown in FIG. 29, is bent to the receiving pipe 111, that is, inward in the radial direction. With this, the housing 160 forms the second wall portion 166 covering the coil 140 at the end opposite to the first wall portion 162. At this time, by forming the protruding portions at three positions 165 in the peripheral direction of the housing 160, as shown in FIG. 30, three second wall portions 166 are formed at predetermined intervals in the peripheral direction. That is, the second wall portions 166 are formed discontinuously in the peripheral direction. While an example in which three protruding portions 165 are provided is shown in FIG. 30, the number of protruding portions 165 can be arbitrarily selected according to a desired magnetic attracting force, in case it is more than one or two.

By bending the protruding portions 165 inward in the radial direction, the inside ends in the radial direction of the formed second wall portions 166 are brought into contact with the outside wall of the second magnetic portion 111c of the receiving pipe 111. Further, the bent protruding portions 165 form neck portions 167 extending from the second wall portion 166 to the side opposite to the cylinder portion 161. The neck portions 167 form an inside diameter nearly equal to the outside diameter of the receiving pipe 111 and their inner peripheral walls are brought into contact with the receiving pipe 111. Since the ends of the inner peripheral side of the second wall portion 166 and the neck portions 167 are brought into contact with the receiving pipe 111, the housing 160 is magnetically connected to the second magnetic portion 111c of the receiving pipe 111. Here, the small-diameter portion 164 and the neck portions 167 may be welded to the receiving pipe 111.

In the second wall portions 166 shown in FIG. 30, ends 166a in the peripheral direction can be brought into contact with the resin-formed part 145 of the coil 140 or the preventive part 146 (both not shown). The second wall portions 166 are brought into contact with the preventive part 146 to prevent the relative turn between the housing 160 and the coil 140.

In the ninth embodiment, the housing 160 is integrally formed without a seam. Hence, the magnetic circuit can be formed without increasing the number of parts. Further, in the ninth embodiment, the cylindrical portion 161 and the first wall portion 162 of the housing 160 surround the outer peripheral side of the receiving pipe 111 along the entire periphery in the peripheral direction. Hence, the sectional area of the housing 160 through which the magnetic flux flows is increased to stabilize the magnetic circuit. Further, by bending the protruding portions 165 to the inner peripheral side, the housing 160 is fixed to the receiving pipe 111. With this, the housing 160 can be formed integrally without a seam and the developed magnetic attracting force can be increased. Therefore, even when the housing 160 is an integrally formed housing, the housing 160 can stabilize the magnetic circuit and can increase the developed magnetic attracting force.

### Tenth Embodiment

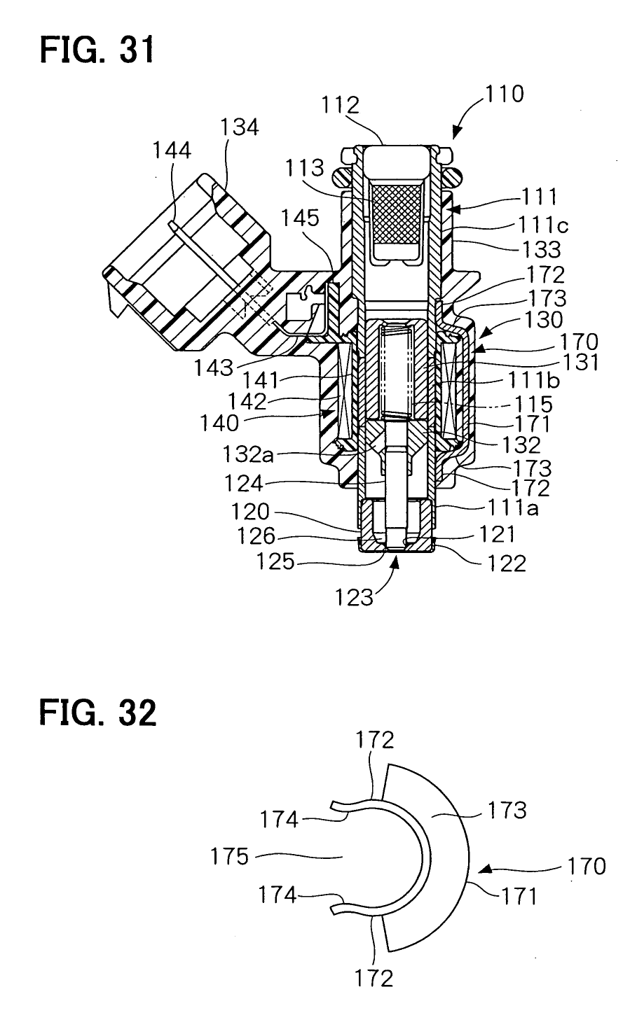

An injector in accordance with the tenth embodiment of the invention is shown in FIG. 31. Here, the substantially same parts as those in the eighth embodiment are denoted by the same reference symbols and their descriptions are omitted.

In the tenth embodiment, a housing 170 is different in the shape. The housing 170 has a side portion 171 and small-diameter portions 172, as shown in FIGS. 31 to 33. The side portion 171 covers a portion in the peripheral direction on the outer peripheral side of the coil 140. With this, the housing 170 is formed nearly in the shape of an arc-like cylinder. The side portion 171 has an inside-diameter larger than the outside diameter of the coil 140 and receives the coil 140.

The housing 170 has the small-diameter portions 172 at both ends in the axial direction of the side portion 171. The small-portions 172 are formed at portions in the peripheral direction like the side portion 171. With this, the small -diameter portions 172 are formed nearly in the shape of an arc-like cylinder. The inside diameter of the small-diameter portions 172 is nearly equal to the outside diameter of the receiving pipe 111. Hence, the inside walls of the small-diameter portions 172 are brought into contact with the outside wall of the receiving pipe 111. The small-diameter portions 172 are arranged on a circumference nearly coaxial with the side portion 171 and are smaller in inside diameter than the side portion 171. Hence, steps are formed between the side portions 171 and the small-diameter portions 172, respectively. These steps form wall portions 173. The wall portions 173 cover the ends of the coil 140 at both ends in the axial direction thereof, respectively. In the housing 170, the side portion 171 and the small-diameter portions 172 are integrally formed of a single part without a seam.

The small-diameter portion 172 has a larger formed angle in the peripheral direction than the side portion 171 and the wall portion 173. For this reason, the small-diameter portion 172 protrudes further in the peripheral direction than the side portion 171 and the wall portion 173. Further, the small diameter portion 172 has snap portions 174 protruding and extending further from both ends in the peripheral direction protruding from the side portion 171 and the wall portion 173. The snap portions 174 can be elastically deformed. Hence, when the housing 170 is mounted on the receiving pipe 111, the inside diameter of the snap portions 174 is expanded. When the receiving pipe 111 is located in the inner peripheral side of the small-diameter portion 172, the inside diameter of the snap portions 174 is contracted.

With this, the snap portions 174 sandwich the receiving pipe 111, whereby the housing 170 is mounted on the receiving pipe 111.

That is, the housing 170 is fitted on the receiving pipe 111 by the small-diameter portions 172 and the snap portions 174. Here, fitted housing 170 may be welded to the receiving pipe 111.

The housing 170 has an opening 175 formed by the peripheral wall forming the side portion 171, the small-diameter portions 172, and the wall portion 173. The opening 175 is formed in such a way as to extend in the axial direction of the housing 170. With this, a portion in the peripheral direction of the housing 170 is formed discontinuously. By forming the opening 175 in the housing 170, the inside and the outside of the housing 170 connect with each other in the radial direction via the opening 175.

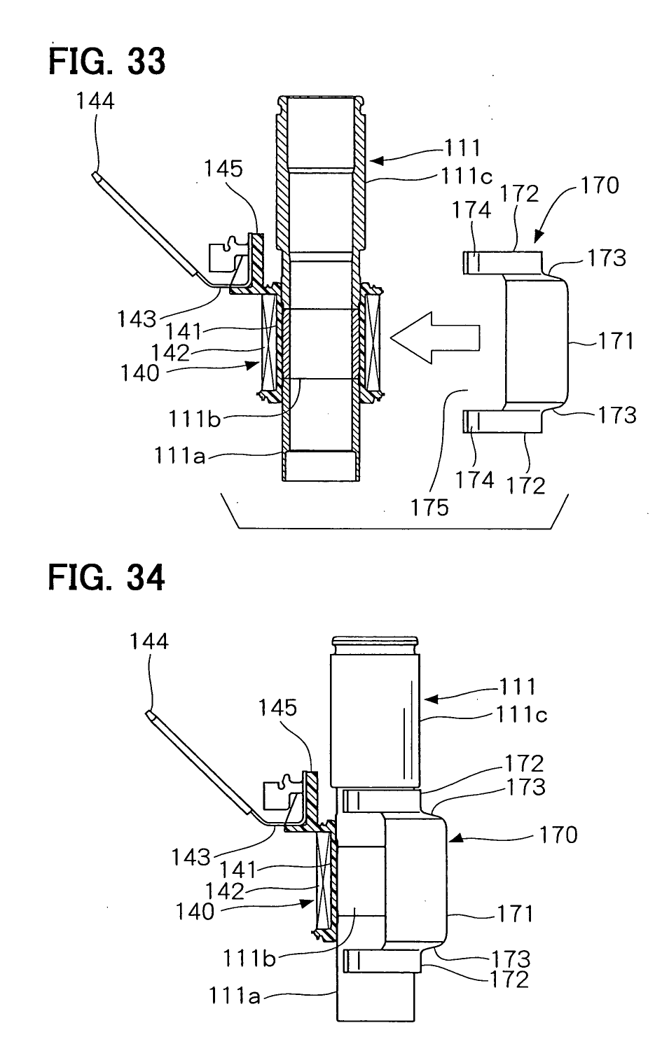

As shown in FIG. 33, the coil 140 is mounted in advance on the outer peripheral side of the receiving pipe 111. The housing 170 is fitted on the outer peripheral side of the receiving pipe 111 mounted with the coil 140. An integrated part of the coil 140 and the receiving pipe 111 is inserted from the outer peripheral side of the housing 170 into the inner peripheral side through the opening 175. At this time, in the housing 170, one small-diameter portion 172 is mounted on the injection port 123 side of the coil 140 and the other small -diameter portion 172 is mounted opposite to the injection port 123 of the coil 140. With this, in the housing 170, one small-diameter portion 172 is fitted on the first magnetic portion 111 a and the other small -diameter portion 172 is fitted on the second magnetic portion 111c. As a result, as shown in FIG. 34, the housing 170 is mounted on the receiving pipe 111.

Since the housing 170 is mounted on the receiving pipe 111, both ends in the axial direction of the coil 140 are covered with the wall portions 173 of the housing 170. Further, the outer peripheral side of the coil 140 is covered with the side portion 171. Still further, since the housing 170 is mounted on the receiving pipe 111, the small-diameter portions 172 are brought into contact with the first magnetic portion 111a and the second magnetic portion 111c, respectively. With this, the housing 170 and the receiving pipe 111 are magnetically connected to each other.

In the tenth embodiment, the housing 170 is fitted on the receiving pipe 111. Hence, the housing 170 can be easily mounted on the receiving pipe 111. Further, in the tenth embodiment, as is the case with the other embodiments, the housing 170 is integrally formed of a single part without a seam. The housing 170 covers the receiving pipe 111 and the coil 140. Therefore, the developed magnetic attracting force can be increased without increasing the number of parts.

### Eleventh Embodiment

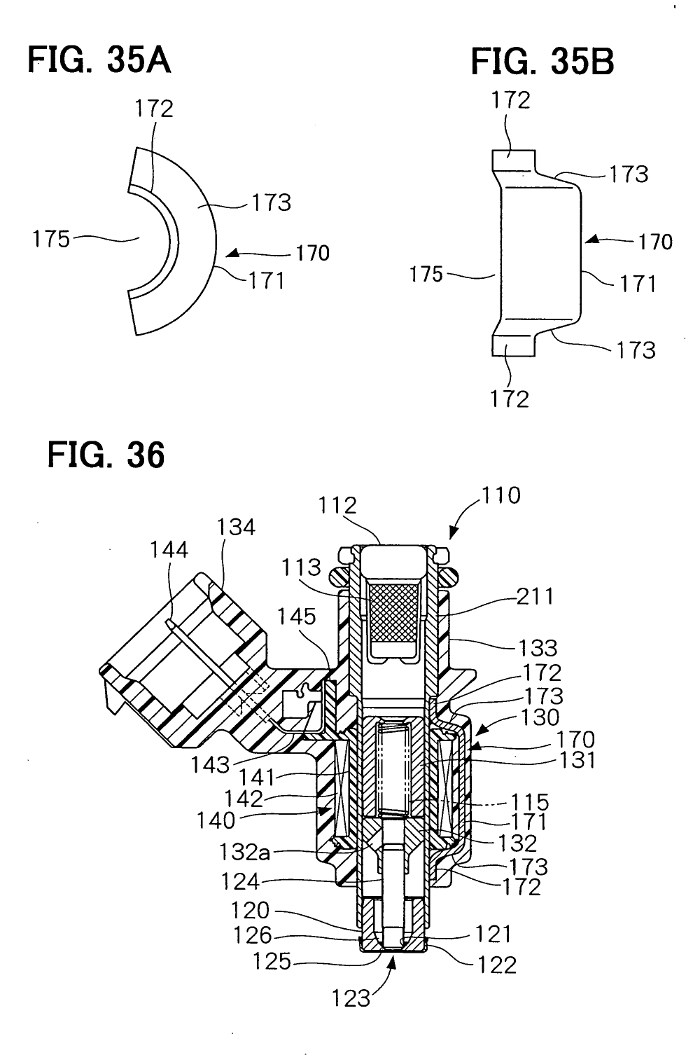

An injector in accordance with the eleventh embodiment of the invention is shown in FIGS. 35A and 35B. Here, the substantially same parts as those in the tenth embodiment are denoted by the same reference symbols and their descriptions are omitted.

In the eleventh embodiment, the housing 170 does not have a portion corresponding to the snap portion 174. For this reason, the angles formed by the side portion 171, the snap portion 172, and the wall portion 173 in the peripheral direction are equal to each other. In the housing 170, the opening 175 is formed at a portion in the peripheral direction by the peripheral wall. The opening 175 is formed in such a way as to extend in the axial direction of the housing 170. In the case of the eleventh embodiment, an integrated part of the coil 140 and the receiving pipe 111 is inserted from the outer peripheral side of the housing 170 into the inner peripheral side through the opening 175. At this time, in the housing 170, one small-diameter portion 172 is mounted on the injection port 123 side of the coil 140 and the other small-diameter portion 172 is mounted opposite to the injection port 123 of the coil 140.

In the eleventh embodiment, the housing 170 is not fitted on the receiving pipe 111. Hence, the housing 170 is mounted on the receiving pipe 111 and then the small-diameter portions 172 are joined to the receiving pipe 111. The small-diameter portions 172 are joined to the receiving pipe 111, for example, by welding or bonding. With this, the housing 170 is fixed to the receiving pipe 111. In the eleventh embodiment, the shape of the housing 170 can be more simplified. Further, in the eleventh embodiment, as is the case with the other embodiments, the housing 170 is integrally formed of a single part without a seam. The housing 170 covers the receiving pipe 111 and the coil 140. Therefore, the developed magnetic attracting force can be increased without increasing the number of parts.

### Twelfth and Thirteenth Embodiments

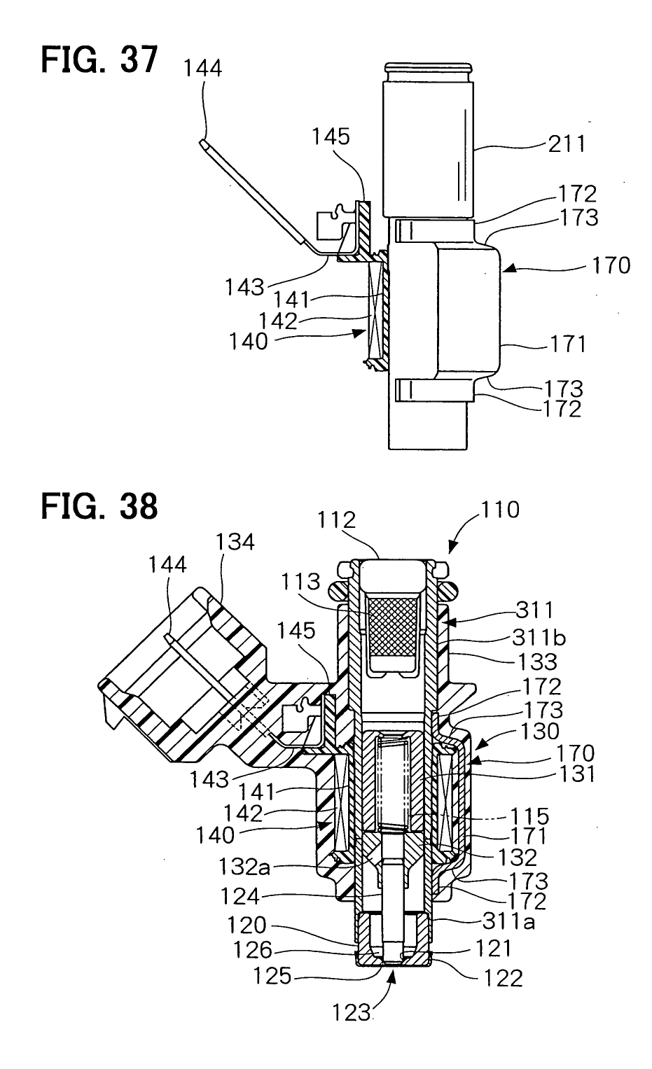

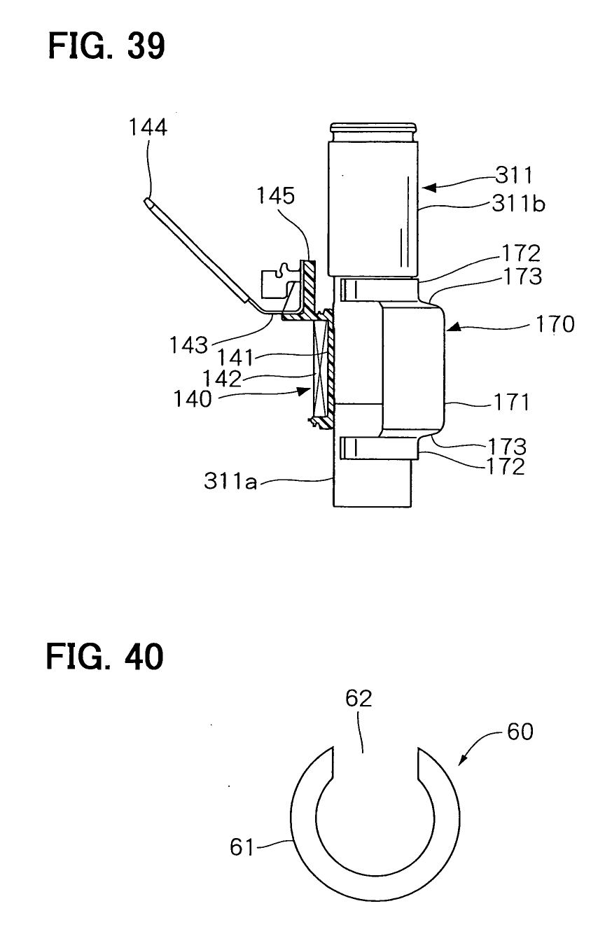

An injector in accordance with the twelfth embodiment of the invention is shown in FIG. 36 and FIG. 37. An injector in accordance with the thirteenth embodiment of the invention is shown in FIG. 38 and FIG. 39. Here, the substantially same parts as those in the tenth embodiment are denoted by the same reference symbols and their descriptions are omitted.

In the eighth embodiment to the eleventh embodiment, a construction the receiving pipe 111 has the first magnetic portion 111a, the non-magnetic portion 111b, and the second magnetic portion 111c has been described as examples. In contrast to this, in the twelfth embodiment, as shown in FIG. 36 and FIG. 37, a receiving pipe 211 is constructed of a single part. At this time, the receiving pipe 211 is formed of a non-magnetic material such as stainless steel.

The receiving pipe 211 is formed in the shape of a cylinder having a thin thickness. For this reason, even when the receiving pipe 211 is formed of a non-magnetic material, the magnetic flux easily passes through the receiving pipe 211. On the injection port 123 side of the coil 140, the receiving pipe 211 is interposed between the small-diameter portion 172 of the housing 170 and the moving core 132. However, as described above, the magnetic flux easily passes through the receiving pipe 211 having a thin thickness. Hence, the flow of the magnetic flux is formed between the small-diameter portion 172 of the housing 170 and the moving core 132. Similarly, on the side opposite to the injection port 123 of the coil 140, the receiving pipe 211 is interposed between the small-diameter portion 172 of the housing 170 and the fixed core 131. However, the magnetic flux easily passes through the receiving pipe 211 having a thin thickness. Hence, the flow of the magnetic flux is formed between the small-diameter portion 172 of the housing 170 and the fixed core 131.

In the twelfth embodiment, the receiving pipe 211 is formed of a single part of a non-magnetic material. Hence, the number of parts can be further reduced. Here, the receiving pipe 211 may be formed of a single part of a non-magnetic material. By forming the receiving pipe 211 in the shape of a cylinder having a thin thickness, the magnetic flux passing through the receiving pipe 211 is easily saturated to prevent the flow of the magnetic flux from being short-circuited. With this, the magnetic flux flows between the housing 170 and the fixed core 131 or the moving core 132 to prevent the magnetic attracting force between the fixed core 131 and the moving core 132 from being reduced.

In the thirteenth embodiment, as shown in FIG. 38 and FIG. 39, a receiving pipe 311 is constructed of two parts of a magnetic part 311a and a non-magnetic part 311b. At this time, the magnetic part 311a and the non-magnetic part 311b are joined to each other, for example, by laser welding or the like. In the case of the thirteenth embodiment, the magnetic part 311 a is formed of a magnetic material. On this account, the magnetic flux easily flows between the small-diameter portion 172 on the injection port 123 side of the housing 170 and the moving core 132. On the other hand, the non-magnetic part 311b is formed of a non-magnetic material. On this account, the receiving pipe 211 is interposed between the small-diameter portion 172 opposite to the injection port 123 side of the housing 170 and the fixed core 131. However, the magnetic flux easily passes through the receiving pipe 211 having a thin thickness to form the flow of the magnetic flux between the small-diameter portion 172 and the fixed core 131.

In the thirteenth embodiment, the receiving pipe 311 is formed of two parts of the magnetic material and the non-magnetic material. Therefore, the number of parts can be reduced as compared with a receiving pipe having a non-magnetic part interposed between two magnetic parts.

### Other embodiments

It is also recommended that the housing 50 described in the first embodiment and shown in FIG. 4 and the housing 50 described in the second embodiment and shown in FIG. 7 be arranged in such a way as to be inverted in the axial direction, as described in the fourth embodiment shown in FIG. 14. In this case, the preventive part is mounted opposite to the resin-formed part 45 of the spool 41. With this, the relative turn in the peripheral direction between the coil 40 and the housing 50 can be prevented.

In the plurality of embodiments described above, examples have been described in which the injection port plate 22 having the injection port 23 is mounted at the tip of the valve body 20. However, the injection port 23 is not formed in the injection port plate 22 but a construction may be adopted in which the injection port 23 is formed in the valve body 20.

Further, in the plurality of embodiments described above, examples have been described in which the internal part is formed of a non-magnetic material and in which the nozzle holder is formed of a magnetic material. However, the internal part and the nozzle holder can be formed of either a non-magnetic material or a magnetic material according to required performance.

Still further, in the plurality of embodiments described above, the constructions have been described in which there is provided the receiving pipe 11 that constructs the internal part and receives the fixed core 31. However, a construction may be adopted in which the fixed core 31 is mounted directly in the housing 50 or 60 without using the receiving pipe 11.

Still further, in the plurality of embodiments described above, examples have been described in which the electromagnetic driver is applied to the injector. However, the electromagnetic driver in accordance with the invention can be applied not only to an injector but also to means for driving a moving part such as valve and armature.

1. An electromagnetic driver comprising:
a coil that has a cylindrical spool and a winding wound around the spool and generates a magnetic field when energized;
an internal part that is inserted in an axial direction through the spool; and
a magnetic part that has an opening for receiving the internal part and is integrally formed as a whole without a seam and covers an outside of the coil.

2. The electromagnetic driver as claimed in claim 1, wherein the magnetic part has a first wall portion that covers one end in an axial direction of the coil, a second wall portion that covers another end in the axial direction of the coil, and a side portion that covers at least a portion in a peripheral direction outside in a radial direction of the coil and connects the first wall portion and the second wall portion,
the first wall portion having a first opening that receives the internal part and a surrounding portion that surrounds an outside of the internal part received in the first opening around an entire periphery in the peripheral direction,
the second wall portion having a second opening that receives the internal part, and the second opening being open to an outer peripheral edge of the second wall portion via a cutout.

3. The electromagnetic driver as claimed in claim 2, wherein the side portion connects one end of the first wall portion in a direction vertical to an axis of the coil and one end of the second wall portion.

4. The electromagnetic driver as claimed in claim 2, wherein the second wall portion has two support portions that support the internal part at both ends in the radial direction of the coil across the second opening and the cutout.

5. The electromagnetic driver as claimed in claim 4, wherein the coil has a preventive part that is brought into contact with the magnetic part to prevent a relative turn in a peripheral direction with respect to the magnetic part.

6. The electromagnetic driver as claimed in claim 5, wherein the preventive part is mounted between the two support portions and is brought into contact with any one of the two support portions at an end in the peripheral direction to prevent a relative turn between the coil and the magnetic part.

7. The electromagnetic driver as claimed in claim 5, wherein the preventive part is opposed to an end opposite to the side portion of the two support portions and is brought into contact with an end opposite to the side portion of the two support portions to prevent a relative turn between the coil and the magnetic part.

8. The electromagnetic driver as claimed in claim 2, wherein the side portion has a first side portion that connects one end of the first wall portion in a direction vertical to an axis of the coil and one end of the second wall portion and a second side portion that connects another end of the first wall portion and another end of the second wall portion.

9. The electromagnetic driver as claimed in claim 8, wherein the second wall portion has a first protruding portion protruding from the first side portion inward in the radial direction of the coil and a second protruding portion protruding from the second side portion inward in the radial direction of the coil, the first protruding portion and the second protruding portion being opposed to each other across the second opening and the cutout.

10. The electromagnetic driver as claimed in claim 9, wherein the coil has a preventive part that is brought into contact with the magnetic part to prevent a relative turn in the peripheral direction with respect to the magnetic part.

11. The electromagnetic driver as claimed in claim 10,
wherein the preventive part is mounted between the first protruding portion and the second protruding portion and is brought into contact with the first protruding portion or the second protruding portion at an end in a peripheral direction to prevent a relative turn between the coil and the magnetic part.

12. The electromagnetic driver as claimed in claim 10, wherein the preventive part is mounted outside in a radial direction of the first protruding portion and the second protruding portion and is brought into contact with the first protruding portion or the second protruding portion at a surface opposite to the magnetic part to prevent a relative turn between the coil and the magnetic part.

13. The electromagnetic driver as claimed in claim 5, wherein the preventive part is formed in such a way as to protrude from an end on the second wall portion side of the spool to a side opposite to the first wall portion.

14. The electromagnetic driver as claimed in claim 13, wherein the preventive part is a resin-formed part that is formed in such a way as to have a wiring part connected to the winding inserted therein.

15. The electromagnetic driver as claimed in claim 13, wherein the preventive part is formed so as to protrude opposite to a resin-formed part that is formed in such a way as to have a wiring part connected to the winding inserted therein.

16. The electromagnetic driver as claimed in claim 5, wherein the preventive part is a plane part that is mounted on an outside wall of the spool and is nearly parallel to a surface on the coil side of the side portion.

17. The electromagnetic driver as claimed in claim 1, wherein the magnetic part has wall portions that cover ends in an axial direction of the coil, respectively, and a side portion that covers at least a portion in a peripheral direction outside in a radial direction of the coil and connects with the wall portions,
the wall portions having an opening for receiving the internal part, the opening being open to an outside edge of the wall portion via a cutout.

18. The electromagnetic driver as claimed in claim 17, wherein the coil has a preventive part that is brought into contact with the magnetic part to prevent a relative turn in a peripheral direction with respect to the magnetic part.

19. The electromagnetic driver as claimed in claim 1, wherein the magnetic part has a first wall portion that covers one end in an axial direction of the coil, a cylindrical portion that connects with the first wall portion at one end in the axial direction and covers at least a portion in a peripheral direction outside in a radial direction of the coil nearly in the shape of a cylinder, and a second wall portion that is connected to an end opposite to the first wall portion of the cylindrical portion and covers an end opposite to the first wall portion of the coil,
the first wall portion having an opening that receives the internal part and a surrounding portion that surrounds at least a portion in the peripheral direction outside in a radial direction of the internal part received in the opening,
the second wall portion covering an end opposite to the first wall portion of the coil in a discontinuous manner in the peripheral direction of the coil.

20. The electromagnetic driver as claimed in claim 19, wherein the magnetic part is in contact with an outside wall of the internal part at an end on an inner peripheral side of the second wall portion.

21. The electromagnetic driver as claimed in claim 19 or 20, wherein the cylindrical portion surrounds an entire periphery in the peripheral direction outside in the radial direction of the coil.

22. The electromagnetic driver as claimed in claim 1,
wherein the magnetic part has a side portion that is mounted nearly parallel to an axis of the coil and covers a portion in the peripheral direction outside in the radial direction of the coil and a small-diameter portion that connects with both ends in an axial direction of the side portion and has an inside diameter smaller than an outside diameter of the side portion, and
wherein the magnetic part forms an opening that extends in an axial direction and has the internal part capable of being inserted into inner peripheral side thereof by a peripheral wall forming the side portion and the small-diameter portion.

23. The electromagnetic driver as claimed in claim 22, wherein the small-diameter portion surrounds at least a portion in the peripheral direction outside the internal part and is fitted on the internal part.

24. A fuel injection valve comprising:
an electromagnetic driver as claimed in claim 1; and
a valve that is driven by the electromagnetic driver to open/close an injection port for injecting fuel.

25. A method for manufacturing an electro-magnetic driver as claimed in claim 19, the method comprising the steps of:
inserting the internal part into an inner peripheral side of the spool;
inserting the internal part inserted into the spool into the opening of the magnetic part; and
bending a protruding portion protruding from the cylindrical portion of the magnetic part to a side opposite to the first wall portion inward in a radial direction of the coil to form the second wall portion covering the first wall portion side of the coil and to bring an end in an inner peripheral side of the protruding portion into contact with an outside wall of the internal part.

26. A method for manufacturing an electro -magnetic driver as claimed in claim 22, the method comprising the steps of:
inserting the internal part into an inner peripheral side of the spool;
inserting the spool and the internal part, which are integrated into one part, into an opening formed by the peripheral wall of the magnetic part from outside in a radial direction to inside; and
connecting the internal part to the small-diameter portion of the magnetic part.

27. A fuel injection valve comprising:
a coil that generates a magnetic field when energized;
a magnetic part that covers both ends in an axial direction of the coil and at least a portion in a peripheral direction of the coil outside in a radial direction of the coil;
an internal part that is mounted in an inner peripheral side of the coil and the magnetic part;
a holding part that is mounted in an outer peripheral side of the internal part and determines a relative position in an axial direction of the magnetic part with respect to the internal part; and a nozzle that is mounted on one end side in an axial direction of the internal part and has an injection port for injecting fuel.

28. The fuel injection valve as claimed in claim 27,
wherein the internal part has a guide portion that receives a moving core on the nozzle side in such a way that the moving core can reciprocate, and
wherein a contact portion of the magnetic part and the internal part is located outside in a radial direction of the moving core and the guide portion.

29. The fuel injection valve as claimed in claim 27, wherein the magnetic part has a first wall portion that covers an end on the nozzle side of the coil, a second wall portion that covers an end opposite to the nozzle of the coil, and a side portion that covers an outside i n a radial direction of the coil, the first wall portion,-the second wall portion, and the side portion being integrally formed without a seam.

30. The fuel injection valve as claimed in claim 27, wherein the holding part is mounted on the nozzle side of the magnetic part.

31. The fuel injection valve as claimed in claim 27, wherein the holding part is mounted opposite to the nozzle of the magnetic part.

32. The fuel injection valve as claimed in claim 27, wherein the holding part is pressed into the internal part.

33. The fuel injection valve as claimed in claim 27, wherein the holding part is fitted in internal part.

34. The fuel injection valve as claimed in claim 27, wherein the coil has a protruding portion that is brought into contact with the magnetic part to prevent a relative turn in a peripheral direction with respect to the magnetic part.

35. The fuel injection valve as claimed in claim 27, wherein the holding part is formed of any one of a non-magnetic material, a magnetic material, and resin.

36. A method for manufacturing a fuel injection valve including:
a coil that generates a magnetic field when energized;
a magnetic part that covers both ends in an axial direction of the coil and at least a portion in a peripheral direction of the coil outside in a radial direction of the coil;
an internal part that is mounted in an inner peripheral side of the coil and the magnetic part; and
a holding part that determines a relative position in an axial direction of the magnetic part with respect to the internal part, the method comprising the steps of:
mounting the coil in the magnetic part;
inserting the internal part in an inner peripheral side of the magnetic part having the coil mounted therein; and
mounting the holding part in the internal part.

37. The method for manufacturing a fuel injection valve as claimed in claim 36, wherein the holding part is pressed in an axial direction from an end in an axial direction of the internal part.

38. The method for manufacturing a fuel injection valve as claimed in claim 36, wherein the holding part is fitted on the internal part from outside in a radial direction of the internal part.

39. The electromagnetic driver as claimed in claim 1, further comprising:
a holding part that is mounted on an outer peripheral side of the internal part and determines a-relative position in an axial direction of the magnetic part with respect to the internal part; and
a nozzle that is mounted on one end side in an axial direction of the internal part and has an injection port for injecting fuel.

40. The electromagnetic driver as claimed in claim 39,
wherein the internal part has a guide portion that receives a moving core on a nozzle side in such a way that the moving core can reciprocate, and
wherein a contact portion of the magnetic part and the internal part is located outside in a radial direction of the moving core and the guide portion.

41. The electromagnetic driver as claimed in claim 39, wherein the magnetic part has a first wall portion that covers an end on the nozzle side of the coil, a second wall portion that covers an end opposite to the nozzle of the coil, and a side portion that covers an outside in a radial direction of the coil, the first wall portion, the second wall portion, and the side portion being integrally formed without a seam.

42. The electromagnetic driver as claimed in claim 39, wherein the holding part is mounted on the nozzle side of the magnetic part.

43. The electromagnetic driver as claimed in claim 39, wherein the holding part is mounted opposite to the nozzle of the magnetic part.

44. The electromagnetic driver as claimed in claim 39, wherein the holding part is pressed into the internal part.

45. The electromagnetic driver as claimed in claim 39, wherein the holding part is fitted in the internal part.

46. The electromagnetic driver as claimed in claim 39, wherein the coil has a protruding portion that is brought into contact with the magnetic part to prevent a relative turn in a peripheral direction with respect to the magnetic part.

47. The electromagnetic driver as claimed in claim 39, wherein the holding part is formed of any one of a non-magnetic material, a magnetic material, and resin.
